(19) United States
(12) Patent Application Publication
(10) Pub. No.: US 2026/0204618 A1
(43) Pub. Date: Jul. 16, 2026

(54) SYSTEMS AND METHODS FOR APPLYING ISOSTATIC PRESSURE ON ELECTROCHEMICAL CELLS

(71) Applicant: Adden Energy, Inc., Waltham, MA (US)

(72) Inventors: William FITZHUGH, Watertown, MA (US); Luhan YE, Boston, MA (US); Xin LI, Belmont, MA (US)

(21) Appl. No.: 19/562,546

(22) Filed: Mar. 10, 2026

Related U.S. Application Data
(63) Continuation of application No. PCT/US2024/046044, filed on Sep. 10, 2024.
(60) Provisional application No. 63/581,925, filed on Sep. 11, 2023.

(51) Int. Cl. H01M 10/04; H01M 10/42; H01M 10/52; H01M 50/211; H01M 50/317

(52) U.S. Cl. CPC H01M 10/0481; H01M 10/425; H01M 10/52; H01M 50/211; H01M 50/317; H01M 2010/4271

(57) ABSTRACT

An electrochemical cell system includes a housing defining an internal volume, an electrochemical cell disposed within the internal volume and a medium disposed in the internal volume around the electrochemical cell. The housing is operably coupled to a pressurizing system which is configured to apply a predetermined pressure on the medium so as to cause the medium to exert a substantially uniform pressure on a surface of the electrochemical cell. The pressure may be in a range of about 0.1 MPa to about 50 MPa.

### CROSS-REFERENCE TO RELATED APPLICATIONS

The present application is a continuation of International Patent Application No. PCT/US2024/046044, filed on Sep. 10, 2024, and entitled “System for Applying Isostatic Pressure on Electrochemical Cells,” which claims priority to and the benefit of U.S. Provisional Patent Application No. 63/581,925, filed on Sep. 11, 2023, and entitled “Systems and Methods for Applying Isostatic Pressure on Electrochemical Cells,” the disclosures of which are hereby incorporated by reference herein in their entirety.

### TECHNICAL FIELD

Embodiments described herein are related to systems and methods for applying pressure on at least one electrochemical cell, e.g., an electrochemical cell stack, disposed in a housing for compressing the at least one electrochemical cell.

### BACKGROUND

Rechargeable electrochemical cells are the key technology to the success of future electronics and electric vehicles (EVs). These electrochemical cells such as pouch cells are generally formed into an electrochemical cell stack by disposing multiple such electrochemical cells on top of each other and disposing the electrochemical cell stack into a housing or can. The application of high external pressure (>1 MPa) on the electrochemical cell stack has emerged as a promising technique to enhance the performance of the electrochemical cell stack. By subjecting these cell stacks to controlled pressure via external mechanical jigs, numerous benefits have been achieved, such as enhanced electrode-electrolyte interface and increased electrolyte densification.

### SUMMARY

Systems and methods described herein relate to electrochemical cell systems including an electrochemical cell disposed within an internal volume defined by a housing, and a medium disposed in the internal volume around the electrochemical cell. The housing is fluidically or mechanically coupled to a pressurizing system configured to apply a predetermined pressure on the medium so as to cause the medium to exert a substantially uniform pressure on a surface of the electrochemical cell. In some embodiments, the electrochemical cell is a solid-state electrochemical cell. In some embodiments, the electrochemical cell includes a liquid electrolyte. In some embodiments, the electrochemical cell systems described herein include an electrochemical cell stack that includes a plurality of the electrochemical cells disposed on each other within the internal volume defined by the housing.

In some embodiments, an electrochemical cell system includes a housing defining an internal volume; at least one electrochemical cell disposed within the internal volume; a medium disposed in the internal volume around the at least one electrochemical cell; and a pressurizing system operably coupled to the housing, the pressurizing system configured to apply a predetermined pressure on the medium to cause the medium to exert a substantially uniform pressure on a surface of the at least one electrochemical cell.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1A is a schematic illustration of an electrochemical cell system including at least one electrochemical cell disposed within a housing defining an internal volume, a medium disposed in the internal volume around the at least one electrochemical cell, a pressurizing system operably coupled (e.g., fluidically or mechanically coupled) to the housing; an optional controller electrically coupled to the at least one electrochemical cell, and an optional safety valve fluidically coupled to the housing, according to an embodiment.

FIG. 1B is a block diagram of an electrochemical cell that may be included in the electrochemical cell system of FIG. 1A, according to an embodiment.

FIG. 2 is an illustration of an electrochemical cell system for applying substantially uniform pressure on one or more electrochemical cells, according to an embodiment.

FIG. 3A is a top perspective view of an electrochemical cell stack disclosed in a housing including a plurality of walls, according to an embodiment; FIG. 3B is a top view of a portion of a first wall and an adjacent second wall of the housing intersecting at a rounder corner, according to an embodiment.

FIG. 4A is a side view of a scaffold that may be used to mount a stack of electrochemical cells in a housing, according to an embodiments; FIG. 4B is a top view of the scaffold of FIG. 4B.

FIG. 5 illustrates the second charge and discharge profiles of a solid-state electrochemical cell disposed in an internal volume of a housing having air at 5 MPa pressure serving as pressurized medium disposed in the internal volume vs. a solid-state electrochemical cell under 10 MPa pressure by a mechanical jig.

FIG. 6 is a schematic flow chart of a method for applying a substantially uniform pressure on an electrochemical cell stack disposed in a housing via a pressurized medium, according to an embodiment.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Systems and methods described herein relate to electrochemical cell systems including at least one electrochemical cell (e.g., one or more electrochemical cell(s)) disposed within an internal volume defined by a housing, and a medium disposed in the internal volume around the at least one electrochemical cell. The housing is operably coupled to a pressurizing system that is configured to apply a predetermined pressure on the medium so as to cause the medium to exert a substantially uniform pressure on a surface of the at least one electrochemical cell. In some embodiments, the at least one electrochemical cell is a solid-state electrochemical cell. In some embodiments, the electrochemical cell systems described herein include a plurality of electrochemical cells disposed on each other to form an electrochemical cell stack disposed into a housing.

Rechargeable electrochemical cells are the key technology to the success of future electronics and electric vehicles (EVs). These electrochemical cells such as pouch cells are generally formed into an electrochemical cell stack by disposing multiple such electrochemical cells on top of each other or side by side and disposing the electrochemical cell stack into a housing or can. The application of high external pressure (>1 MPa) on the electrochemical cell stack has emerged as a promising technique so as to enhance the performance of the electrochemical cell stack, for example, a solid-state electrochemical cell stack.

Several techniques have been used to pressurize solid-state electrochemical cell stacks. Using a mechanical jig to pressurize solid-state electrochemical cell stacks is a common method in research and development settings. A mechanical jig is a device designed to apply controlled pressure to the electrochemical cell stack, including the electrolyte and other components. This pressure helps improve the interfacial contact and densification of the solid-state electrolyte, leading to enhanced battery performance. While mechanical jigs are suitable for research and small-scale development, they are not as practical for large-scale commercial production due to challenges in achieving uniform pressure distribution in larger battery stacks. Moreover, such jigs and plate type pressure mechanisms can be bulky and heavy, which increases the overall weight of a system employing such pressure mechanisms and reduce energy density, which is undesirable. The large weight and volume of such jigs relative to the size of electrochemical cells lowers gravimetric and volumetric energy densities to undesirably low levels. As battery sizes increase, uniformly applying and maintaining the desired pressure throughout the surface of larger battery stack become difficult, potentially leading to non-uniform performance, and reduced overall battery efficiency.

The design of mechanical jigs is typically optimized for obtaining uniaxial pressure, which means that the pressure is applied along a single axis because this type of pressure distribution is easier to achieve and control, ensuring that the force is directed in a specific direction across the solid-state electrochemical cell stack. However, applying high levels of uniaxial stack pressure can subject the electrochemical cell components to significant mechanical shear stress. This stress can lead to deformation or damage to electrochemical cell materials, due to a finite Poisson's ratio, which is particularly true for pouch cells. Excessive pressure can cause cracking, delamination, or even failure of the electrolyte, negatively impacting the battery's performance and lifespan. Mechanical jigs can also cause non-uniform pressure distributions in the electrochemical pressure cells that can lead to performance inconsistencies, which is undesirable. Mechanical jigs are also impractical and challenging to implement on a large scale due to their large volume and heavy weight, hindering scalability and cost-effectiveness. Therefore, they are not suitable for large-scale production of solid-state electrochemical cells for commercial applications, such as electric vehicles, portable electronics, and grid energy storage systems.

Because solid-state batteries generally deliver and maintain exceptional electronic performance only when operating under high pressure, this is a limiting factor inhibiting their commercialization. Automotive OEMs (original equipment manufacturers) generally consider viable solid state electrochemical cells as one operating at a pressure of less than 100 psi (about 0.7 MPa). This understanding of OEMs is based on conventional pressure application technology that uses heavy mechanical jigs and pressure plates on the electrochemical cell.

The fact that most solid-state batteries better maintain good performance under high pressures is a limiting factor for their commercialization. For a solid-state battery to be viable for electric vehicles, it is generally desirable that such vehicles are operated at a pressure of less than approximately 100 psi (about 0.7 MPa). However, this threshold of 100 psi is based on what the OEMs have experienced with commercial lithium-ion batteries with the pressure being applied by mechanical jigs.

On the contrary, embodiments of systems and methods described herein for applying a substantially uniform pressure force on one or more electrochemical cells using a pressurized medium, may provide one or more benefits including, for example: (1) providing a substantially uniform pressure from all directions, i.e., isostatic pressure, ensuring even and consistent pressure distribution across the entire electrochemical cell stack, which leads to uniform densification of an electrolyte such as a solid-state electrolyte included in the electrochemical cell(s) thereby, increasing capacity and decreasing side reactions; (2) improving mechanical stability of the electrochemical cell(s) and reducing the risk of mechanical failure during operation by using a pressurized medium having minimal or no shear stress; (3) allowing tailoring or adjusting of a magnitude of force or pressure being exerted on the electrochemical cell stack; (4) being compatible with different electrochemical cell designs and materials, thereby allowing various configurations and form factors according to desired volume and weight requirements; (5) being scalable, thus allowing integration into automated production lines, enabling efficient mass production of pressurized electrochemical cell(s) for a variety of applications, for example, electric vehicles or grid storage; (6) enabling improvement in performance of solid-state electrochemical cells by application less than half of the pressure that would be applied by mechanical jigs to attain the same improvement in performance; (7) increasing pressure threshold that can be applied on electrochemical cells without any substantial increase in weight or complexity of systems including such electrochemical cells; (8) having a simple design that reduces manufacturing time and cost; and (9) enhancing safety by capturing (e.g., neutralizing) hazardous gases formed from off-gassing of the one or more electrochemical cells.

The electrochemical cell stacks described herein may exhibit higher specific capacity, longer cycle life, and improved safety compared to the electrochemical cell stacks pressed by mechanical jigs. The enhanced electrochemical and mechanical properties can contribute to better overall battery performance.

In some embodiments, the electrochemical cells described herein can include an anode disposed on an anode current collector; a cathode disposed on a cathode current collector; and a separator disposed between the anode and the cathode. In some embodiments, the separator includes a solid state electrolyte multilayer i.e., at least two layers, e.g., at least three. In some embodiments, the separator includes a first solid state electrolyte disposed on the anode; and a second solid state electrolyte disposed on the first solid state electrolyte. In some embodiments, the electrochemical cell (e.g., a solid state battery) may include a bipolar structure, for example, anode and cathode materials can be disposed on two sides of one current collector and the electrochemical cell is stacked in series with other electrochemical cells. Examples of electrochemical cells including a solid state electrolyte multilayer are described in PCT Publication No. WO2022/094412, entitled “Batteries with Solid State Electrolyte Multilayers”, the entire disclosure of which is hereby incorporated by reference.

As used herein, the singular forms “a,” “an,” and “the” include plural referents unless the context clearly dictates otherwise. Thus, for example, the term “an electrochemical cell” is intended to mean a single electrochemical cell or a plurality of electrochemical cell, “a material” is intended to mean one or more materials, or a combination thereof.

As used herein, the term “substantially uniform pressure” implies that the pressure applied may vary ±10% across the entire surface or volume being considered. When used in connection with an electrochemical cell, the term “substantially uniform pressure” is intended to convey a pressure variation of equal to or less than 10% across the surface area of an electrochemical cell or an electrochemical cell stack.

As used herein, the term “set,” and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Additionally, for example, when referring to a plurality of electrochemical cells, the plurality of electrochemical cells can be considered as multiple, distinct electrochemical cells or as one electrochemical cell with multiple portions. Thus, a set of portions or a plurality of portions may include multiple portions that are either continuous or discontinuous from each other.

As used herein, the term “example” as used herein to describe various embodiments or arrangements is intended to indicate that such embodiments or arrangements are possible examples, representations, and/or illustrations of possible embodiments or arrangements (and such term is not intended to connote that such embodiments or arrangements are necessarily crucial, extraordinary, or superlative examples).

As used herein, the term “including”, “comprising”, or “having”, “containing”, “involving” and variations thereof herein, is meant to encompass the items listed thereafter as well as, optionally, additional items. In the description the same numerical references refer to similar elements.

As used herein, the term “about” or “generally” or the like in the context of a given value or range (whether direct or indirect, e.g., “generally in line”, “generally aligned”, “generally parallel”, etc.) refers to a value or range that is within 20%, preferably within 10%, and more preferably within 5% of the given value or range.

As used herein, the term “low shear strength solid” refers to solid materials having a shear strength of no more than about 100 MPa. For example, the low shear strength solid can include aerogels, foams, rubber particles, polymer particles, sand, silica, clay, any other suitable low shear strength solid, carbon particles, or any suitable combination thereof.

As used herein, the term “solid-state electrochemical cell” refers to an electrochemical cell including an anode, a cathode, and a solid state electrolyte disposed between the anode and the cathode. In some embodiments, the solid state electrolyte may include a solid state electrolyte multilayer i.e., at least two layers, e.g., at least three.

As used herein, the term “electrical communication” refers to the juxtaposition of two materials such that the two materials contact each other sufficiently to conduct either an ion or electron current.

As used herein, the term “non-flammable” refers to compounds or compositions which are determined to be nonflammable as determined in accordance with American Society for Testing and Materials (ASTM) standards E-681, dated 2002, which is incorporated herein by reference.

As used herein, the term “non-corrosive” refers to a substance that will not corrode or deteriorate another surface or substance with which it comes into contact through chemical action.

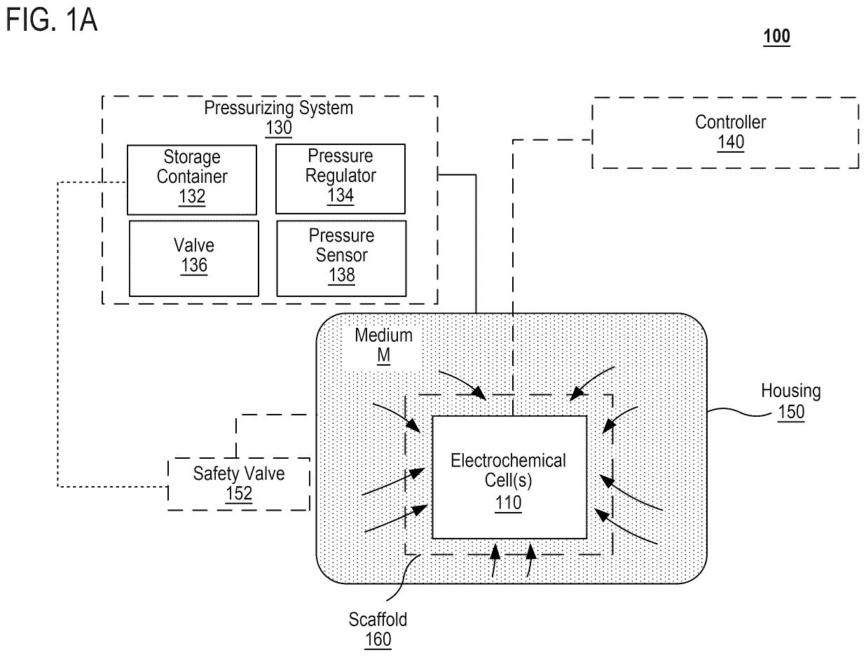

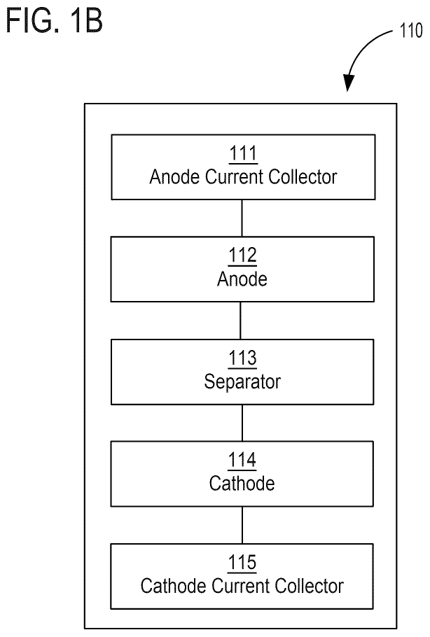

FIG. 1A is schematic illustration of an electrochemical cell system 100 (also referred to herein as “system 100”), according to an embodiment. The system 100 may include at least one electrochemical cell 110 disposed within a housing 150 defining an internal volume, a medium M disposed in the internal volume around the at least one electrochemical cell 110, a pressurizing system 130 operably coupled (e.g., fluidically and/or mechanically) coupled to the housing 150, and optionally, a controller 140 electrically coupled to the at least one electrochemical cell 110, an optional safety valve 152 fluidically or mechanically coupled to the housing 150, and an optional scaffold 160 that is configured to hold the electrochemical cell 110 in place within the housing 150. In some embodiments, the pressurizing system 130 is configured to be detachable from the housing 150.

As shown in FIG. 1A, the housing 150 defines an internal volume in which the at least one electrochemical cell 110, for example, an electrochemical cell stack, and the medium M are disposed. The medium M is disposed between and in contact with the housing 150 and the at least one electrochemical cell 110. In some embodiments, the at least one electrochemical cell 110 includes a plurality of electrochemical cells that are stacked on top of one another or side by side to form an electrochemical cell stack. In some embodiments, the plurality of electrochemical cells 110 disposed in the housing 150 can be coupled, stacked or connected to each other in parallel. In some embodiments, the plurality of electrochemical cells 110 included in the housing 150 can be coupled, stacked or connected to each other in series.

The housing 150 can be formed from a strong, rigid, and heat-resistant material. In some embodiments, the housing 150 includes iron, iron alloys, aluminum, aluminum alloys, titanium alloys, stainless steel, carbon steel, galvanized steel, carbon compounds and their alloys, plastics, carbon or glass fiber filled plastic, polymers, any other suitable material, or a combination thereof. In some embodiments, the housing 150 may be coated with corrosion or flame resistance material (e.g., TEFLON®, Nylon, aluminum oxide, titanium oxide, corrosion and/or flame resistance paint, etc.). In some embodiments, the housing 150 is configured to be lightweight and occupy minimal volume with respect to the volume of the electrochemical cell(s) 110 in order to maintain power/volume efficiency.

While FIG. 1A shows the housing 150 as having a substantially rectangular shape, this is for illustrative purposes only and the housing 150 may have any other three-dimensional (3D) shape, for example, substantially cuboid, rectangular prism, pentagonal prism, hexagonal prism, trapezoidal prism, octagonal prism, cylindrical, circular, any other suitable shape, or a combination thereof. The housing 150 can be formed using any manufacturing process that allows fluidic and/or mechanical coupling with the pressurizing system 130. For example, the housing 150 can be formed by deep drawing, blanking, fine blanking, hydroforming, stamping, injection molding, blow molding, vacuum forming, any other suitable process, or combination thereof. In some embodiments, the housing 150 may be composed of at least two parts (not shown), e.g., a lid and a base. The pieces of the housing 150 may be connected to each other via hinges, screws, bolts and nuts, rivets, adhesives, welding, clamps, interlocking joints or combination thereof such that the housing 150 can enclose the at least one electrochemical cell 110 and the medium M within the internal volume of the housing 150. In some embodiments, the housing 150 may be configured to be hermetically sealed to inhibit leakage of the medium M from within the internal volume thereof. In some embodiments, one or more ports can be provided on a wall, base, and/or lid of the housing 150 to allow medium M to be communicated into the internal volume of the housing 150, for example, to compensate for any medium M lost due to leaks.

In some embodiments, the housing 150 includes a plurality of walls coupled to each other or monolithically formed, such that the plurality of walls may have rounded corners. Embodiments of the housing with rounded corners offer several advantages over conventional rectilinear battery housings including, for example, maintaining uniform and constant pressure on the electrochemical cells, and between the cells and the inside walls of the housing, being stronger and stiffer than rectilinear housings without being thicker or heavier, enabling efficient air flow between adjacent curved battery housings when disposed in a stack, for example, in an electric vehicle setting, thereby enabling more efficient cooling of the housings. In contrast, the conventional rectilinear housings, e.g., battery cans, often do not provide even pressure to the cells because the sides of the housing can bulge with internal pressure and the resulting non-uniform pressure on the cells can lead to performance degradation.

In some embodiments, each of the rounded corners at the intersection of each of the plurality of walls of the housing 150 may have a radius of curvature in a range of about 0.1 mm to about 100 m, inclusive (e.g., about 0.1, 0.5, 1, 5, 10, 50, 100 mm; about 1, 1.5, 2.0, 2.5, 3.0, 3.5, 4.0, 4.5, 5.0, 10, 50, 100 cm; about 2, 5, 10, 50, 100 m, inclusive). In some embodiments, each of the rounded corners at the intersection of each of the plurality of walls of the housing 150 may have a radius of curvature in a range of about 0.5 mm to about 5 cm, about 1 mm to about 5 cm, about 5 mm to about 5 cm, about 10 mm to about 5 cm, about 50 mm to about 5 cm, about 100 mm to about 5 cm, about 200 mm to about 5 cm, about 300 mm to about 5 cm, about 500 mm to about 5 cm, about 500 mm to about 5 cm, about 600 mm to about 5 cm, about 700 mm to about 5 cm, about 800 mm to about 5 cm, about 900 mm to about 5 cm, about 1 cm to about 5 cm.

In some embodiments, each of the rounded corners at the intersection of each of the plurality of walls of the housing 150 may have a radius of curvature in a range of about 1 cm to about 5 cm, inclusive (e.g., about 1, 1.5, 2.0, 2.5, 3.0, 3.5, 4.0, 4.5, or 5.0 cm, inclusive). In some embodiments, each of the rounded corners may have a radius of curvature of at least 0.1 mm. In some embodiments, each of the rounded corners may have a radius of curvature of at least 1 cm. In some embodiments, each of the rounded corners may have a radius of curvature of at least 1.5 cm. In some embodiments, each of the rounded corners may have a radius of curvature of at least 2 cm. In some embodiments, each of the rounded corners may have a radius of curvature of at least 2.5 cm. In some embodiments, each of the rounded corners may have a radius of curvature of at least 3 cm. In some embodiments, each of the rounded corners may have a radius of curvature of at least 3.5 cm. In some embodiments, each of the rounded corners may have a radius of curvature of at least 4 cm. In some embodiments, each of the rounded corners may have a radius of curvature of at least 4.5 cm.

In some embodiments, each of the rounded corners may have a radius of curvature of at most 100 m. In some embodiments, each of the rounded corners may have a radius of curvature of at most 50 m. In some embodiments, each of the rounded corners may have a radius of curvature of at most 10 m. In some embodiments, each of the rounded corners may have a radius of curvature of at most 1 m. In some embodiments, each of the rounded corners may have a radius of curvature of at most 500 cm. In some embodiments, each of the rounded corners may have a radius of curvature of at most 100 cm. In some embodiments, each of the rounded corners may have a radius of curvature of at most 50 cm. In some embodiments, each of the rounded corners may have a radius of curvature of at most 10 cm. In some embodiments, each of the rounded corners may have a radius of curvature of at most 6 cm. In some embodiments, each of the rounded corners may have a radius of curvature of at most 5.5 cm. In some embodiments, each of the rounded corners may have a radius of curvature of at most 5.0 cm. In some embodiments, each of the rounded corners may have a radius of curvature of at most 4.5 cm. In some embodiments, each of the rounded corners may have a radius of curvature of at most 4.0 cm. In some embodiments, each of the rounded corners may have a radius of curvature of at most 3.5 cm. In some embodiments, each of the rounded corners may have a radius of curvature of at most 3 cm. In some embodiments, each of the rounded corners may have a radius of curvature of at most 2.5 cm. In some embodiments, each of the rounded corners may have a radius of curvature of at most 2 cm. Various combinations of radius of curvatures are envisioned (e.g., radius of curvature of at least about 1 cm but not more than about 5 cm, or at least about 2 cm but not more than 4.5 cm) and should be considered to be within the scope of this disclosure.

In some embodiments, each of the plurality of walls of the housing 150 can have a thickness in a range of about 25 microns to about 1,000 mm, inclusive (e.g., about 25, 50, 75, 100, 500 microns, 1, 5, 10 mm, 50 mm, 100 mm, 200 mm, 300 mm, 400 mm, 500 mm, 600 mm, 700 mm, 800 mm, 900 mm, or 1,000 mm inclusive). In some embodiments, each of the plurality of walls of the housing 150 can have a thickness of at least 25 microns. In some embodiments, each of the plurality of walls of the housing 150 can have a thickness of at least 50 microns. In some embodiments, each of the plurality of walls of the housing 150 can have a thickness of at least 100 microns. In some embodiments, each of the plurality of walls of the housing 150 can have a thickness of at least 0.1 mm. In some embodiments, each of the plurality of walls of the housing 150 can have a thickness of at least 0.5 mm. In some embodiments, each of the plurality of walls of the housing 150 can have a thickness of at least 1 mm. In some embodiments, each of the plurality of walls of the housing 150 can have a thickness of at least 5 mm. In some embodiments, each of the plurality of walls of the housing 150 can have a thickness of at least 10 mm. In some embodiments, each of the plurality of walls of the housing 150 can have a thickness of at least 50 mm. In some embodiments, each of the plurality of walls of the housing 150 can have a thickness of at least 100 mm. In some embodiments, each of the plurality of walls of the housing 150 can have a thickness of at least 500 mm. In some embodiments, each of the plurality of walls of the housing 150 can have a thickness of at least 1,000 mm.

In some embodiments, each of the plurality of walls of the housing 150 can have a thickness of at most 1,000 mm. In some embodiments, each of the plurality of walls of the housing 150 can have a thickness of at most 500 mm. In some embodiments, each of the plurality of walls of the housing 150 can have a thickness of at most 100 mm. In some embodiments, each of the plurality of walls of the housing 150 can have a thickness of at most 10 mm. In some embodiments, each of the plurality of walls of the housing 150 can have a thickness of at most 5 mm. In some embodiments, each of the plurality of walls of the housing 150 can have a thickness of at most 1 mm. In some embodiments, each of the plurality of walls of the housing 150 can have a thickness of at most 0.5 mm. In some embodiments, each of the plurality of walls of the housing 150 can have a thickness of at most 0.1 mm. In some embodiments, each of the plurality of walls of the housing 150 can have a thickness of at most 50 microns. Various combinations of wall thicknesses are envisioned (e.g., thickness of at least about 50 microns but no more than about 10 mm, or at least about 0.1 mm but no more than 1 mm) and should be considered to be within the scope of this disclosure.

In some embodiments, the electrochemical cells(s) 110 includes a plurality of electrochemical cells 110 disposed in a stack. In such embodiments, outer surface of outer most electrochemical cells 110 included in the stack may contact a corresponding inner surface of a respective wall of the plurality of walls of the housing 150. For example, an outer surface of a first outermost electrochemical cell disposed on a first end of stack along a first direction may contact an inner surface of a corresponding first wall of the plurality of walls of the housing 150, and an outer surface of a second outermost electrochemical cell disposed on a second end of the stack opposite the first end may contact an inner surface of a corresponding second wall of the plurality of walls opposite the first wall. In some embodiments, a gap may exist between outer edges of the electrochemical cells 110 located along a second direction that is perpendicular to the first direction. In some embodiments, the medium M may be configured to penetrate between the outer surfaces of the outer most electrochemical cells and corresponding inner surfaces of the first and second wall, and/or between adjacent electrochemical cells 110 included in the stack to exert the substantially uniform pressure or isostatic pressure on the electrochemical cell(s) 110.

In some embodiments, the system 100 includes the safety valve 152 (e.g., a check valve, a pressure release nozzle, spring loaded safety valve, pilot operated safety valve, deadweight safety valve, diaphragm safety valve, lever safety valve, full-lift safety valve, high lift safety valve, conventional safety valve, balanced safety valve, angle safety valve, bellows safety valve, any other suitable safety valve or combination thereof) fluidically coupled to the housing 150. The safety valve 152 may be configured to enable depressurizing of the internal pressure of the housing 150 when an internal pressure within the internal volume exceeds a predetermined pressure, thereby preventing damage (e.g., rupture) of the housing 150 and/or over pressurizing of the electrochemical cell(s) 110. In some embodiments, the housing 150 may be fluidically or mechanically connected to the safety valve 152. That is, the housing 150 and the safety valve 152 are connected such that a fluid, e.g., a gas or a liquid, can be transported from the internal volume of the housing 150 to the safety valve 152 while the functionality of both housing 150 and the safety valve 152 is maintained. The safety valve 152 may automatically release a portion of the medium M in the housing 150 to a region outside the housing 150 (e.g., the external atmosphere) when the internal pressure in the housing 150 becomes higher than the predetermined pressure. The safety valve 152 can be mounted on the outer surface of the housing 150 or connected to the housing 150 through a suitable connector, e.g., pressure resistant tubing, hose, piping, etc. The safety valve 152 is configured to reduce overpressure on the at least one electrochemical cell 110, or a pressure within the housing 150, to a desired level in the event of cell failure or a safety hazard, thereby preventing fire or thermal runaway. In some embodiments, the safety valve 152 is configured to reduce overpressure on the at least one electrochemical cell 110 to a desired level within an hour, 50 minutes, 40 minutes, 30 minutes, 20 minutes, 10 minutes, 50 minutes, or 1 minute.

The electrochemical system 100 may include a controller 140, e.g., an electrochemical cell cycler, in electrical communication with the at least one electrochemical cell 110 disposed within the housing 150. The controller 140 can perform charge/discharge cycles on the electrochemical cell(s) 110 to determine certain properties of the electrochemical cell(s) 110 such as cell capacity, performance, and/or life cycle, or otherwise control operations of the electrochemical cell(s) 110. The controller 140 can perform at least one discharge/charge cycle on the at least one electrochemical cell 110 disposed in the housing 150 at a predetermined current density and at a predetermined temperature. Thermal chambers (not shown) may be used to create controlled temperature conditions for performing charge/discharge cycles on the electrochemical cell(s) 110 under different temperature conditions. In some embodiments, the controller 140 or electronics associated with controller 140 or the system 100 (e.g., a battery management system) may be housed in, or mounted on a portion of the housing 150. In some embodiments, the housing 150 may include ports, openings, glands, or any other structures configured to serve as feedthroughs for electrical leads, wires, or cables for electrically coupling the electrochemical cell(s) 110 disposed in the internal volume of the housing 150 to the controller 140 or other electronics (e.g., a battery management system) disposed outside of the internal volume of the housing 150.

As shown in FIG. 1A, a pressurizing system 130 is operably (e.g., fluidically and/or mechanically) coupled to the housing 150 such that the pressurizing system can apply a predetermined pressure on the medium M so as to cause the medium M to exert a substantially uniform pressure on a surface of the at least one electrochemical cell 110. In some embodiments, the medium M includes at least one of a gas, a liquid, a sublimating liquid, or a low shear-strength solid. In some embodiments, the medium M includes a gas. In such embodiments, the gas may include, but is not limited to air, hydrogen, helium, nitrogen, argon, neon, krypton, xenon, any other suitable gas, or any suitable combination thereof. In some embodiments, the medium M includes a liquid. Suitable liquids may include, but are not limited to hydraulic fluids, silicone oils, mineral oils, non-aqueous fluids, electrolytes, any other suitable liquid, or a combination thereof. The hydraulic fluids can be mineral oil-based, synthetic, or biodegradable, depending on the specific requirements of the system 100. In some embodiments, the liquid includes water-glycol mixtures. The liquid may include specific additives, e.g., abrasives, refrigerants, which may be mixed with liquids to enhance their performance and safety of the system 100. In some embodiments, the medium M has a shear strength of no more than about 30 MPa, no more than about 20 MPa, no more than about 10 MPa, no more than about 5 MPa, no more than about 3 MPa, no more than about 1 MPa, no more than about 0.5 MPa, no more than about 0.3 MPa, no more than about 0.1 MPa, no more than about 0.05 MPa, no more than about 0.01 MPa. In some embodiments, the medium M may also provide other benefits including, for example, cooling, or serve as a flame retardant.

In some embodiments, the medium M can include at least one of a non-flammable material, a non-corrosive material, or a non-reactive material. In some embodiments, the medium M is configured to capture or neutralize (e.g., react with, bind, mitigate, suppress, etc.) at least one byproduct released during operation of the electrochemical cell 110, for example, formed from off-gassing of the electrochemical cell 110. In some embodiments, the medium M is configured to capture a gas including at least one of H₂S, CO, HF, SO₂, NO₂, NO, HCl, or any other toxic sulfide gas. In some embodiments, the medium M is configured to bind the at least one byproduct formed from off-gassing of the electrochemical cell 110 via covalent and/or non-covalent interactions. Accordingly, in some embodiments, the medium M can serve a dual purpose, functioning both as a pressurization agent and a safety mechanism by preventing release of toxic byproducts from the off-gassing of the electrochemical cells into other part of the system 100. Off-gassing in electrochemical cells, such as lithium-ion batteries, involves the release of gases produced by electrochemical and chemical reactions within the cell. This can happen during both the operation and storage of the battery. Elevated temperatures, increased discharge currents, and improper charging or discharging can accelerate gas production. Off-gassing can increase the pressure within the housing 110, and thus the pressure exerted on the electrochemical cell 110. The medium M can advantageously capture and/or neutralize one or more off-gases generated from the electrochemical cells, thus inhibiting increase of pressure on the electrochemical cell 110 beyond a desired threshold, and/or inhibit or reduce release of dangerous off-gases into the environment.

In some embodiments, the medium M includes a low shear strength solid. In some embodiments, the low shear strength solid have a shear strength of no more than about 100 MPa, no more than about 5 MPa, no more than about 1 MPa, no more than about 0.05 MPa, no more than about 0.01 MPa, no more than about 0.001 MPa. In some embodiments, the low shear strength solid have a shear strength of less than 1 MPa. In some embodiments, the low shear strength solid includes solid particles. The solid particles may be in the form of nanoparticles, microparticles, microspheres or hollow microspheres. In some embodiments, the low shear strength solid is selected from the group of aerogels, foams, rubber particles, polymer particles, sand, silica, clay, any other suitable low shear strength solid, carbon particles, or any suitable combination thereof. In some embodiments, low shear-strength solid includes sand. Using a low shear strength solid as the medium M may reduce leakage from the housing 150 relative to a gaseous or liquid medium, which may make implementation easier in commercially applications. In some embodiments, the low shear strength solid medium M may also serve as a flame retardant to increase safety of the system 100.

Expanding further, and without wishing to be bound by any particular theory, while gases and liquid mediums M can be used to apply substantially uniform pressure with no shear stresses, certain solid mediums M can also be used to apply near uniform pressure or nearly zero shear stresses. One such example is a granular powder (e.g., sand). In “soil mechanics” it is seen that a bulk of such granular soil can sustain shear stresses but only up to a maximum value before the grains of soil move to reduce the shear. The maximum shear the soil can sustain, the “shear strength” (τ), is given by the cohesion (c), the angle of friction (φ), and the effective normal stress (σ), as follows:

$$τ = c + σ tan ( ϕ )$$

Similarly, certain solids with low intrinsic shear strengths could also potentially be used, for example, clay, gel, or any of the low shear strength solids described herein. Clay or gel can plastically deform at low relative shear strengths. Either granular powders or low-shear-strength solids could be used if the shear strength of the solid is less than the shears that arise during the pressurization of the assembly. In such a case, the solids would deform to relieve any shear stress. This process of relieving the shear stress can also improve the uniformity of the pressure.

The pressurizing system 130 shown in FIG. 1A, is operably coupled (e.g., fluidically or mechanically coupled) to the housing 150 (e.g., via one or more ports provided in the housing 140) and configured to apply a predetermined pressure on the medium M or otherwise, pressurize the medium so as to cause the medium M to exert a substantially uniform pressure on a surface of the at least one electrochemical cell 110. In some embodiments, the medium M (e.g., a liquid, solid, or gas) may already be present in an unpressurized state in the internal volume of the housing 150 when the electrochemical cell(s) 110 are disposed therein. In such embodiments, the pressurization system may be activated to cause a pressure to be exerted on the medium M or otherwise, pressurize the medium M such that the medium M exerts the substantially uniform pressure on the electrochemical cell(s) 110. In some embodiments, the pressurize medium M is communicated into the housing 150 once the electrochemical cell(s) 150 have been disposed therein.

In some embodiments, the substantially uniform pressure is in a range of about 0.05 MPa to about 15 MPa, 0.05 MPa to about 12 MPa, 0.05 MPa to about 10 MPa, 0.05 MPa to about 9 MPa, 0.05 MPa to about 8 MPa, 0.05 MPa to about 7 MPa, 0.05 MPa to about 6 MPa, 0.05 MPa to about 5.5 MPa, 0.1 MPa to about 15 MPa, 0.5 MPa to about 15 MPa, 1 MPa to about 15 MPa, 10 MPa to about 15 MPa.

In some embodiments, the substantially uniform pressure is in a range of about 0.05 MPa to about 5 MPa, about 0.05 MPa to about 4.5 MPa, about 0.05 MPa to about 4 MPa, about 0.05 MPa to about 3.5 MPa, about 0.05 MPa to about 3 MPa, about 0.05 MPa to about 2.5 MPa, about 0.05 MPa to about 2 MPa, about 0.05 MPa to about 1.5 MPa, about 0.05 MPa to about 1 MPa, about 0.05 MPa to about 0.5 MPa, about 0.1 MPa to about 5 MPa, about 0.1 MPa to about 4.5 MPa, about 0.1 MPa to about 4 MPa, about 0.1 MPa to about 3.5 MPa, about 0.1 MPa to about 3 MPa, about 0.1 MPa to about 2.5 MPa, about 0.1 MPa to about 2 MPa, about 0.1 MPa to about 1.5 MPa, about 0.1 MPa to about 1 MPa, about 1 MPa to about 5 MPa, about 1 MPa to about 4.5 MPa, about 1 MPa to about 4 MPa, about 1 MPa to about 3.5 MPa, about 1 MPa to about 3 MPa, about 1 MPa to about 2.5 MPa, about 1 MPa to about 2 MPa, about 1 MPa to about 1.5 MPa.

In some embodiments, the substantially uniform pressure is in a range of about 0.2 MPa to about 5 MPa.

In some embodiments, the substantially uniform pressure is at least about 0.01 MPa. In some embodiments, the substantially uniform pressure is at least about 0.05 MPa. In some embodiments, the substantially uniform pressure is at least about 0.1 MPa. In some embodiments, the substantially uniform pressure is at least about 0.2 MPa. In some embodiments, the substantially uniform pressure is at least about 0.3 MPa. In some embodiments, the substantially uniform pressure is at least about 0.4 MPa. In some embodiments, the substantially uniform pressure is at least about 0.5 MPa. In some embodiments, the substantially uniform pressure is at least about 1 MPa. In some embodiments, the substantially uniform pressure is at least about 1.5 MPa. In some embodiments, the substantially uniform pressure is at least about 2 MPa. In some embodiments, the substantially uniform pressure is at least about 2.5 MPa. In some embodiments, the substantially uniform pressure is at least about 3.0 MPa.

In some embodiments, the substantially uniform pressure is at most about 15.0 MPa. In some embodiments, the substantially uniform pressure is at most about 12.0 MPa. In some embodiments, the substantially uniform pressure is at most about 10.0 MPa. In some embodiments, the substantially uniform pressure is at most about 9.0 MPa. In some embodiments, the substantially uniform pressure is at most about 8.0 MPa. In some embodiments, the substantially uniform pressure is at most about 7.0 MPa. In some embodiments, the substantially uniform pressure is at most about 6.0 MPa. In some embodiments, the substantially uniform pressure is at most about 5.0 MPa. In some embodiments, the substantially uniform pressure is at most about 4.5 MPa. In some embodiments, the substantially uniform pressure is at most about 4.0 MPa. In some embodiments, the substantially uniform pressure is at most about 3.5 MPa. In some embodiments, the substantially uniform pressure is at most about 3.0 MPa. In some embodiments, the substantially uniform pressure is at most about 2.5 MPa. In some embodiments, the substantially uniform pressure is at most about 2.0 MPa. In some embodiments, the substantially uniform pressure is at most about 1.5 MPa. In some embodiments, the substantially uniform pressure is at most about 1.0 MPa.

In some embodiments, ratio of a uniaxial first pressure exerted by a mechanical jig to an isostatic second pressure exerted by the pressurized medium to obtain the same improvement in performance of the solid state electrochemical cell 110 is at least 1.5. In some embodiments, the ratio between the first pressure and the second pressure to obtain the same improvement in performance of the solid state electrochemical cell 110 is at least 1.6. In some embodiments, the ratio between the first pressure and the second pressure to obtain the same improvement in performance of the solid state electrochemical cell 110 is at least 1.7. In some embodiments, the ratio between the first pressure and the second pressure to obtain the same improvement in performance of the solid state electrochemical cell 110 is at least 1.8. In some embodiments, the ratio between the first pressure and the second pressure to obtain the same improvement in performance of the solid state electrochemical cell 110 is at least 1.9. In some embodiments, the ratio between the first pressure and the second pressure to obtain the same improvement in performance of the solid state electrochemical cell 110 is at least 2.0. In some embodiments, the ratio between the first pressure and the second pressure to obtain the same improvement in performance of the solid state electrochemical cell 110 is at least 2.1. In some embodiments, the ratio between the first pressure and the second pressure to obtain the same improvement in performance of the solid state electrochemical cell 110 is at least 2.2. In some embodiments, the ratio between the first pressure and the second pressure to obtain the same improvement in performance of the solid state electrochemical cell 110 is at least 2.3. In some embodiments, the ratio between the first pressure and the second pressure to obtain the same improvement in performance of the solid state electrochemical cell 110 is at least 2.4. In some embodiments, the ratio between the first pressure and the second pressure to obtain the same improvement in performance of the solid state electrochemical cell 110 is at least 2.5. In some embodiments, the ratio between the first pressure and the second pressure to obtain the same improvement in performance of the solid state electrochemical cell 110 is at least 2.6. In some embodiments, the ratio between the first pressure and the second pressure to obtain the same improvement in performance of the solid state electrochemical cell 110 is at least 2.7. In some embodiments, the ratio between the first pressure and the second pressure to obtain the same improvement in performance of the solid state electrochemical cell 110 is at least 2.8. In some embodiments, the ratio between the first pressure and the second pressure to obtain the same improvement in performance of the solid state electrochemical cell 110 is at least 2.9. In some embodiments, the ratio between the first pressure and the second pressure to obtain the same improvement in performance of the solid state electrochemical cell 110 is at least 3.0. In some embodiments, the ratio between the first pressure and the second pressure to obtain the same improvement in performance of the solid state electrochemical cell 110 is in a range of about 1.5 to about 3.0.

In some embodiments, the pressurizing system 130 may include a storage container 132, pressure regulator 134, one or more valves 136 and a pressure sensor 138. At least two elements of the pressurizing system 130, e.g., storage container 132, pressure regulator 134, one or more valves 136, safety valve 152 and a pressure sensor 138, are in fluid communication with each other. The elements of the pressurizing system 130 may be connected to each other via manifolds such as pressure resistant pipes and tubes. Various fittings and connectors, e.g., flanges, couplings, and adapters, can be used to join the pressure resistant pipes and tubes together.

In some embodiments, the pressurizing system 130 may include a storage container 132 and a pressure regulator 134. The storage container 132 is configured to hold or contain a volume of the medium M for communicating to the housing 150. In some embodiments in which the medium M includes a gas, the storage container 132 can include a pressure tank or vessel configured to hold or contain the gas at a predetermined pressure. In some embodiments in which the medium M includes a liquid or solid, the storage container 132 is configured to hold a predetermined volume of the liquid or solid for communicating to the housing 150. In such embodiments, a pump (e.g., a centrifugal pump, a positive displacement pump, a blower, a vacuum pump), or other pressurizing mechanism (e.g., an extruder in the case of a particulate matter based solid) may be used to pressurize the liquid or solid. In some embodiments in which the medium M includes a solid, the solid may be predisposed in the internal volume of the housing 150 around the electrochemical cell(s) 110 and the storage container 132 may contain a pressurized gas. The pressurized gas may be configured to selectively exert a pressure on the solid disposed in the housing 150, which in turn exerts a substantially uniform pressure on the electrochemical cell(s) 110 disposed in the housing 150. In some embodiments, the safety valve 152 may also be in fluid communication with the storage container 132, for example, via a return line, and configured to return medium M expelled from the housing 150 through the safety valve 152 to be returned to the storage container 132, thus inhibiting loss of the medium M to the environment.

The pressure regulator 134 ensures the pressure downstream of the regulator 134 remains within a desired range (e.g., at or about the predetermined pressure to be applied on the electrochemical cell(s) 110), even if the upstream pressure, e.g., pressure from the storage container, fluctuates. In some embodiments in which the medium M includes a gas, the pressure regulator 134 may include a single stage regulator, a two stage regulator, a line pressure regulator, a high pressure regulator, a low pressure regulator, a general purpose regulator, an adjustable regulator, a cylinder regulator, any other suitable pressure regulator or a combination thereof, and configured to regulate, control, or adjust a pressure of the medium M. In some embodiments in which the medium M is a liquid or a solid, the pressure regulator may include any suitable pumping or pressurizing mechanism, as described herein.

In some embodiments, the pressurizing system 130 further includes one or more valves 136 to control flow of a fluid throughout the pressurizing system, for example, to selectively allow flow of the medium M from the storage container 132. In some embodiments, the one or more valves 136 further controls efficient flow of a fluid from the pressurizing system 130 to the housing 150. The valve 136 can be operated manually or automatically. In some embodiments, the valve 136 can include T-valves, gate valves, globe valves, ball valves, check valves, solenoid valves, diaphragm valves, needle valves butterfly valves, any other suitable valve or any suitable combination thereof. In some embodiments, the pressurizing system 130 further includes a pressure sensor 138. The pressure sensor 138 may be installed at various points (not shown) in the system 130 to monitor and display the pressure levels within the system 130, for example, a pressure exerted on the medium M, or by the medium M on the electrochemical cell(s) 110. The pressure sensor 138 may help keep track of the pressure during time and detect any abnormalities or deviations, as well as provide feedback to maintain the substantially uniform pressure on the electrochemical cell(s) 110 within a predetermined range.

Referring to FIG. 1A, the electrochemical system 100 may include a scaffold 160 to hold the electrochemical cells in place when a predetermined pressure is applied on the medium. In some embodiments, the scaffold 160 holds the electrochemical cells in place during charge/discharge cycling. In some embodiments, the scaffold 160 prevents the electrochemical cell 110 being damaged when a predetermined pressure is applied on the medium to cause the medium to exert a substantially uniform pressure on a surface of the electrochemical cell 110.

While FIG. 1A shows the scaffold 160 as having a substantially rectangular shape, this is for illustrative purposes only and the scaffold 160 may have any three-dimensional (3D) shape. In some embodiments, the scaffold 160 does not prevent the contact between medium M and the surface of electrochemical cell 110. That is, the scaffold 160 is designed such that it allows passage of medium M through the surface of the electrochemical cell 110.

In some embodiments, the electrochemical cell 110 can be mounted on the scaffold 160. In some embodiments, the scaffold 160 is in the form of a mechanical hand (e.g., with two, three, four or multiple fingers) attached to an internal wall of the housing 150. In some embodiments, the scaffold 160 may include a plurality of elongate elements (e.g., bars, struts, beams, etc.) coupled to each other such that slots, cavities, or receptacles are defined between sets of bars within which individual electrochemical cells 110 included in a stack of electrochemical cells can be disposed. Openings may be formed in the sides of the scaffold 160 exposing one or more surfaces of the electrodes thus allowing expansion of the electrochemical cells at least partially through the openings as well as allow the medium M easy access to the exposed surface of the electrochemical cell 110 to exert the substantially uniform pressure thereon. In addition, the scaffold 160 can be structured such that a gap or space is provided between each of the electrochemical cells 110 when the electrochemical cells 160 are disposed in their respective slots. Such a gap or space may advantageously allow expansion of the electrochemical cells on both sides, as well as allow the medium M to access a surface of the electrochemical cells 110 that faces a corresponding surface of an adjacent electrochemical cell. For example, the gap or space between adjacent electrochemical cells 110 provided by the scaffold 160 can accommodate the volume changes of the electrochemical cells 110 during cycling. For example, electrochemical cells 110 can get expanded during charge/discharge cycling, and the space or gap provided the scaffold 160 may prevent two adjacent electrochemical cells 110 from contacting each other, thereby increasing the performance. Moreover, such an arrangement can beneficially facilitate exertion of the substantially uniform pressure by the medium M on each of the electrochemical cells 110 included in internal volume supported by the scaffold 160 by exposing more surfaces of the electrochemical cells 110 for the medium M to come in contact with, and exert the substantially uniform pressure thereon.

In some embodiments, the space or gap between the electrochemical cells 110 may be between about 50 microns to about 1 cm, or about 100 microns to about 1 cm, or about 1 mm to about 1 cm. In some embodiments, the space between the electrochemical cells 110 may be between about 50 microns to about 100 microns, about 50 microns to about 500 microns, about 50 microns to about 1 mm, about 50 microns to about 10 mm, and about 100 microns to about 10 mm.

FIG. 1B is a schematic block diagram of the electrochemical cell 110 that may be disposed in the housing 150, according to an embodiment. While FIG. 1B shows a particular embodiment of the electrochemical cell 110 that may be disposed in the housing 150, this is for illustrative purposes only and the electrochemical cell 110 can include any other electrochemical cells having any suitable structure or formulation. All such embodiments are envisioned and should be considered to be within the scope of the present disclosure.

As shown in FIG. 1B, the electrochemical cell 110 includes an anode 112 disposed on an anode current collector 111, a cathode 114 disposed on a cathode current collector 114, and a separator 113 disposed between the anode 112 and the cathode 114. In some embodiments, the separator 113 includes a solid state electrolyte. In some embodiments, the separator includes: a first solid state electrolyte disposed on the anode, the first solid state electrolyte being stable with respect to an alkali metal; and a second solid state electrolyte disposed on the first solid state electrolyte, the second solid state electrolyte being reactive with respect to the alkali metal.

In some embodiments, the anode 112, the anode current collector 111, the cathode 114, the cathode current collector 115 and the separator 113 can be disposed in a pouch (not shown), for example, an aluminum pouch, a mica pouch, a polymer pouch, etc. In some embodiments, the anode 112, the anode current collector 111, the cathode 114, the cathode current collector 115 and the separator 113 can be disposed in a prismatic cell (not shown).

The anode 112 includes an anode active material. In some embodiments, the anode 112 can include an anode conductive material. In some embodiments, the anode 112 can include a solid anode. The anode 112 is disposed on the anode current collector 111 and is configured to receive electrons therefrom. In some embodiments, the anode current collector 111 includes copper, aluminum, nickel, titanium, or any combination thereof.

In some embodiments, the anode 112 has a thickness between 0 μm and 1000 μm, 0 μm and 500 μm, 0 μm and 100 μm, 10 μm and 1000 μm, 10 μm and 500 μm, 10 μm and 100 μm, 100 μm and 1000 μm, 100 μm and 500 μm. The thickness of “0 μm” means that the battery can be made with an anode-free design.

In some embodiments, the anode 112 includes at least one of Li, Na, Mg, Al, Si, K, Ca, Sc, Ti, V, Cr, Mn, Fe, Co, Ni, Cu, Zn, Ga, Ge, As, Rb, Sr, Y, Zr, Nb, Mo, Ag, Cd, In, Sn, Sb, Bi, Cs, Te, or a combination thereof (e.g., as an alloy). In some embodiments, the anode 112 includes Li or Na metal. In some embodiments, the anode 112 includes carbon. In some embodiments, the carbon includes graphite, hard carbon, amorphous carbon, carbon nanotube, graphene, carbon nanofiber, or a fullerene. In some embodiments, the anode further includes a protective layer (not shown) including at least one of Li, Na, Mg, Al, Si, K, Ca, C, Sc, Ti, V, Cr, Mn, Fe, Co, Ni, Cu, Zn, Ga, Ge, As, Rb, Sr, Y, Zr, Nb, Mo, Ag, Cd, In, Sn, Sb, Bi, Cs, Te, or a combination thereof.

In some embodiments, the anode 112 includes Na and a protective layer or coating disposed thereon. The protective layer or coating may include at least one of graphite, silicon, silicon dioxide, Na₄Ti₅O₁₂, Na₃V₂O₅, Au, Ag, Sn, SnO₂, carbon (e.g., amorphous carbon, carbon nanotube, graphene, carbon nanofiber, fullerenes (e.g., C₆₀ fullerene), hard carbon, or graphite), Na, a mixture of Na with a polymer, a polymer, or combination thereof.

In some embodiments, the anode 112 includes Li and a protective layer or coating including at least one of silicon, silicon dioxide, Li₄Ti₅O₁₂, Li₃V₂O₅, carbon (e.g., amorphous carbon, carbon nanotube, graphene, carbon nanofiber, fullerenes (e.g., C₆₀ fullerene), hard carbon, or graphite), Au, Ag, Sn, SnO₂, Li, a mixture of Li with a polymer, a polymer or a combination thereof.

The cathode 114 includes a cathode active material. In some embodiments, the cathode 114 can include a cathode conductive material. In some embodiments, the cathode active material may be mixed with a polymer, carbon or a combination thereof. Examples of polymers that may be mixed with the cathode active material may include, but not limited to, polyethylene oxide, polyvinylidene fluoride, poly(vinylidene fluoride-co-hexafluoropropylene), poly(ethyl methacrylate), or poly(vinylidene fluoride-co-trifluoroethylene). In some embodiments, the cathode 114 can include a solid cathode. The cathode 114 is disposed on the cathode current collector 115 and is configured to communicate electrons thereto. In some embodiments, the cathode current collector 115 can include aluminum, stainless steel or any other suitable current collector material.

In some embodiments, the cathode includes at least one of LiNi_{0.8}Mn_{0.1}Co_{0.1}O₂ (NMC811), LiNi_{0.33}Mn_{0.33}Co_{0.33}O₂(NMC111), LiNi_{0.5}Mn_{0.3}Co_{0.2}O₂(NMC532), LiNi_{0.6}Mn_{0.2}Co_{0.2}O₂(NMC622), LiNi_{0.9}Mn_{0.05}Co_{0.05}O₂(NMC955), LiNiₓMn_{y}Co_{(1-x-y)}O₂ (0≤x,y≤1), LiNiₓCo_{y}Al_{(1-x-y)}O₂ (0≤x,y≤1), LiMn₂O₄, LiMnO₂, LiNiO₂, Li_{1+z}NiₓMn_{y}Co_{(1-x-y-z)}O₂ (0≤x,y,z≤1), Li_{1+z}NiₓMn_{y}Co_{w}Al_{(1-x-y-z-s)}O₂ (0≤x,y,z,s≤1), Li_{1+z}NiₓMn_{y}CoₛW_{(1-x-y-z-s)}O₂ (0≤x,y,z,w≤1), V₂O₅, selenium, sulfur, selenium-sulfur compound, LiCoO₂ (LCO), LiFePO₄, LiNi_{0.5}Mn_{1.5}O₄, Li₂CoPO₄F, LiNiPO₄, Li₂Ni(PO₄)F, LiMnF₄, LiFeF₄, or LiCo_{0.5}Mn_{1.5}O₄. In some embodiments, the cathode can be coated with a protective layer including at least one of LiNbO₃, LiTaO₃ Li₂ZrO₃, LiNbₓTa₁₋ₓO₃ (0≤x≤1), yLi₂ZrO₃-(1-y)LiNbxTa₁₋ₓO₃ (0≤x, y≤1), Al₂O₃, TiO₂, ZrO₂, AlF₃, MgF₂, SiO₂, ZnS, ZnO, Li₄SiO₄ Li₃PO₄, Li₃InCl₆, Li₁₊ₓAlₓTi₂₋ₓ(PO₄)₃ (0<x<2), LiMn₂O₄, LiInO₂—LiI, Li₆PS₅Cl, LiAlO₂, a polymer, or carbon.

In some embodiments, the cathode includes at least one of Na_{w}MnO₂, Na_{w}CoO₂, Na_{w}NiO₂, Na_{w}TiO₂, Na_{w}VO₂, Na_{w}CrO₂, Na_{w}FeO₂, Na_{w}(MnₓFe_{y}Co_{z}Ni_{1-x-y-z})O₂ (0≤x,y,z≤1), Na_{w}(M)PO₄, Na_{w}(M)P₂O₇, Na_{w}(M)O₂, NaₓM_{y}(XO₄)_{z}; where M is a metal element or a combination of metal elements, e.g., transition metal elements; where X is B, S, P, Si, As, Mo, W, or a combination thereof; where 0≤x,y,z≤3; 0<w≤1; and where O can be partially replaced by F, Cl, Br, or I. In some embodiments, the cathode can be coated with a protective layer including at least one of NaNbO₃, NaTaO₃, Na₂ZrO₃, NaNbₓTa₁₋ₓO₃ (0≤x≤1), yNa₂ZrO₃-(1-y)NaNbxTa₁₋ₓO₃ (0≤x, y≤1), Al₂O₃, TiO₂, ZrO₂, AlF₃, MgF₂, SiO₂, ZnS, ZnO, Na₄SiO₄, Na₃PO₄, Na₃InCl₆, Na₁₊ₓAlₓTi₂₋ₓ(PO₄)₃ (0≤x<2), NaMn₂O₄, NaInO₂-Nal, Na₆PS₅Cl, NaAlO₂, or carbon.

In some embodiments, the protective layers can be used to coat anode, cathode or combination thereof. The protective layers may enhance the safety and performance of the battery by preventing the contact between the electrolyte, e.g., solid electrolyte, and other battery components. The composition of protective layers varies according to the composition of the anode 112, the cathode 114 or combination thereof.

In some embodiments, the protective layer includes particles. In some embodiments, the particles have a particles size of 1 nm to 100 μm, e.g., about 1-100 nm (e.g., about 1-10 nm, 1-25 nm, 10-20 nm, 20-30 nm, 25-50 nm, 30-40 nm, 40-50 nm, 50-60 nm, 50-75 nm, 60-70 nm, 70-80 nm, 75-100 nm, 80-90 nm, or 90-100 nm, e.g., about 1 nm, 5 nm, 10 nm, 20 nm, 30 nm, 40 nm, 50 nm, 60 nm, 70 nm, 80 nm, 90 nm, or 100 nm), e.g., about 100-1000 nm (e.g., about 100-110 nm, 100-125 nm, 100-200 nm, 200-300 nm, 250-500 nm, 300-400 nm, 400-500 nm, 500-600 nm, 500-750 nm, 600-700 nm, 700-800 nm, 750-1000 nm, 800-900 nm, or 900-1000 nm, e.g., about 100 nm, 200 nm, 300 nm, 400 nm, 500 nm, 600 nm, 700 nm, 800 nm, 900 nm, or 1000 nm), e.g., about 1-10 μm (e.g., about 1-2 μm, 1-5 nm, 2-3 μm, 3-4 μm, 4-5 μm, 5-10 μm, 5-6 μm, 6-7 μm, 7-8 μm, 8-9 μm, or 9-10 μm, e.g., about 1 μm, 2 μm, 3 μm, 4 μm, 5 μm, 6 μm, 7 μm, 8 μm, 9 μm, or 10 μm), or, e.g., about 10-100 μm (e.g., about 10-20 μm, 10-25 μm, 10-50 μm, 20-30 μm, 25-50 μm, 30-40 μm, 40-50 μm, 50-60 μm, 50-75 μm, 60-70 μm, 75-100 μm, 70-80 μm, 80-90 μm, or 90-100 μm, e.g., about 10 μm, 12 μm, 13 μm, 14 μm, 15 μm, 16 μm, 17 μm, 18 μm, 19 μm, 20 μm, 21 μm, 22 μm, 23 μm, 24 μm, 25 μm, 26 μm, 27 μm, 28 μm, 29 μm, 30 μm, 40 μm, 50 μm, 60 μm, 70 μm, 80 μm, 90 μm, or 100 μm).

In some embodiments, the cathode 114 is mixed with a solid state electrolyte selected from the group consisting of Li_{0.375} O_{0.5} P_{0.125}, Li_{0.3} Br_{0.6} Er_{0.1}, Li_{0.166} B_{0.166} O_{0.5} Al_{0.125} Cl_{0.041}, Li_{0.081} O {0.648} Al_{0.027} P_{0.162} Ti_{0.081}, Li_{0.3} Cl_{0.6} Er_{0.1}, Li_{0.3} Cl_{0.6} Y_{0.1}, Li_{0.3} Cl_{0.6} Sc_{0.1}, Li_{0.265} O_{0.510} Al_{0.010} Zr_{0.085} La_{0.127}, Li_{0.271} O_{0.508} Ga_{0.008} Zr_{0.084} La_{0.127}, Li_{0.276} O_{0.510} Zr_{0.063} Nb {0.021} La_{0.127}, Li_{0.270} O_{0.515} Zr_{0.070} La_{0.128} W_{0.015}, Li_{0.3} Cl_{0.6} In_{0.1}, Li_{0.291} O {0.5} Zr_{0.083} La_{0.125}, Li_{0.3} Br_{0.6} In_{0.1}, Li_{0.3} Sc_{0.1} Br_{0.6}, Li_{0.3} Br_{0.6} Y_{0.1}, Li_{0.260} P_{0.173} S {0.565}, Li_{0.304} P_{0.043} S_{0.521} Ge_{0.130}, Li_{0.310} P_{0.152} S_{0.537}, Li_{0.308} P_{0.153} S_{0.536} I_{0.001}, Li_{0.333} P_{0.142} S_{0.523}, Li_{0.333} P_{0.142} S_{0.523}, Li_{0.333} P_{0.142} S_{0.523}, Li_{0.325} B_{0.181} S_{0.377} I_{0.115}, Li {0.337} P_{0.139} S_{0.522} Mo_{0.000}, Li_{0.333} P_{0.138} S_{0.509} Mn_{0.004} I_{0.014}, Li_{0.375} P_{0.125} S {0.5}, H_{0.004} Li_{0.373} B_{0.001} P_{0.124} S_{0.496}, Li_{0.390} P_{0.121} S_{0.487}, Li_{0.385} Si_{0.070} P_{0.052} S_{0.473} Cl_{0.012} Sb_{0.005}, Li_{0.390} P_{0.097} S_{0.487} Sn_{0.024}, Li_{0.385} Si_{0.070} P_{0.058} S_{0.473} Cl_{0.012}, Li_{0.393} P_{0.090} S_{0.484} Ge_{0.030}, Li_{0.4} Si_{0.04} P_{0.08} S_{0.48}, Li_{0.4} Si_{0.04} P_{0.08} S_{0.48}, Li_{0.4} P_{0.08} S_{0.48} Ge_{0.04}, Li_{0.388} P_{0.111} S_{0.444} I_{0.055}, Li_{0.400} B_{0.000} O_{0.000} Al_{3.503} Si_{0.133} S_{0.465}, Li_{0.4} P_{0.08} S_{0.48} Sn_{0.04}, Li_{0.4} P_{0.08} S_{0.48} Sn_{0.04}, Li_{0.423} Al_{0.038} P_{0.076} S_{0.461}, Li_{0.433} S_{0.452} As_{0.018} Sn_{0.094}, Li_{0.444} S_{0.444} Sn_{0.111}, Li_{0.44} P_{0.08} S_{0.36} Cl_{0.108} I_{0.012}, Li_{0.428} P_{0.142} S_{0.428}, Li_{0.44} P_{0.08} S_{0.36} Cl_{0.12}, Li_{0.44} F_{0.032} P_{0.08} S_{0.36} Cl_{0.088}, Li_{0.44} P_{0.08} S_{0.36} Cl_{0.108} Br_{0.012}, Li_{0.461} O_{0.076} P_{0.076} S_{0.307} Cl_{0.076}, Li_{0.416} Si_{0.106} S_{0.363} I_{0.113}, Li_{0.6} O_{0.2} Cl_{0.2}, Li_{0.461} P_{0.076} S_{0.384} I_{0.076}, Li_{0.461} P_{0.076} S_{0.384} Cl_{0.076}, Li_{0.461} P_{0.076} S_{0.384} Br_{0.076}, Li_{0.481} P_{0.074} S_{0.407} Cl_{0.037}, Li_{0.475} Si_{0.026} P_{0.048} S_{0.374} Br_{0.074}, Li_{0.6} O_{0.2} Br_{0.2}, Li_{0.485} P_{0.029} S_{0.367} Ge_{0.044} I_{0.073}, Li_{0.5} P_{0.071} S_{0.428}, Li_{0.3+x} Cl_{0.6−y} Er_{0.1−z}, Li_{0.3+x} Cl_{0.6−y} Y_{0.1−z}, Li {0.081+x} O_{0.648−y} Al_{0.027+z} P_{0.162−w} Ti_{0.081−1}, Li_{0.3+x} Cl_{0.6−y} Sc_{0.1−z}, Li_{0.3+x} Br_{0.6−y} Er_{0.1−z}, Li_{0.265+x} O_{0.510−y} Al_{0.010−z} Zr_{0.085+w} La_{0.127+1}, Li_{0.271+x} O_{0.508−y} Ga_{0.008−z} Zr_{0.084+w} La_{0.127+1}, Li_{0.276+x} O_{0.510−y} Zr_{0.063+z} Nb_{0.021−w} La_{0.127+1}, Li_{0.166+x} B_{0.166−y} O_{0.5−z} Al_{0.125+w} Cl_{0.041+1}, Li_{0.291+x} O_{0.5−y} Zr_{0.083−z} La_{0.125−w}, Li_{0.270+x} O_{0.515−y} Zr_{0.070−z} La_{0.128+w} W_{0.015−1}, Li_{0.400−x} B_{0.000−y} O_{0.000−z} Al_{3.503+w} Si_{0.133−1} S_{0.465−m}, Li_{0.3+x} Cl {0.6−y} In_{0.1−z}, Li_{0.3+x} Sc_{0.1−y} Br_{0.6−z}, Li_{0.3+x} Br_{0.6−y} Y_{0.1−z}, Li_{0.3+x} Br_{0.6−y} In {0.1−z}, Li_{0.325−x} B_{0.181+y} S_{0.377+z} I_{0.115−w}, Li_{0.260+x} P_{0.173+y} S_{0.565−z}, Li_{0.375+x} P_{0.125+y} S_{0.5−z}, Li_{0.304+x} P_{0.043+y} S_{0.521−z} Ge_{0.130+w}, Li_{0.310+x} P_{0.152+y} S_{0.537−z}, Li {0.333+x} P_{0.142+y} S_{0.523−z}, Li_{0.333+x} P_{0.142+y} S_{0.523−z}, Li_{0.333+x} P_{0.142+y} S_{0.523−z}, Li_{0.375+x} O_{0.5−y} P_{0.125−z}, Li {0.308+x} P_{0.153+y} S_{0.536−z} I_{0.001−w}, Li_{0.333+x} P_{0.138+y} S_{0.509−z} Mn_{0.004−w} I_{0.014+1}, Li_{0.337+x} P_{0.139+y} S_{0.522−z} Mo_{0.000+w}, Li_{0.6−x} O_{0.2−y} Cl_{0.2+z}, Li_{0.388+x} P_{0.111+y} S_{0.444−z} I_{0.055+w}, H_{0.004+x} Li_{0.373+y} B_{0.001−z} P_{0.124+w} S_{0.496−1}, Li_{0.461+x} O_{0.076+y} P_{0.076−z} S_{0.307−w} Cl_{0.076−1}, Li_{0.390+x} P_{0.097+y} S_{0.487−z} Sn_{0.024+w}, Li_{0.393+x} P_{0.090+y} S_{0.484−z} Ge_{0.030+w}, Li_{0.6+x} O_{0.2+y} Br_{0.2−z}, Li_{0.390+x} P_{0.121+y} S_{0.487−z}, Li_{0.4+x} P_{0.08+y} S_{0.48−z} Ge_{0.04+w}, Li_{0.385+x} Si_{0.070+y} P_{0.052−z} S_{0.473−w} Cl_{0.012−1} Sb_{0.005−m}, Li_{0.385+x} Si_{0.070+y} P_{0.058−z} S_{0.473−w} Cl_{0.012−1}, Li_{0.416+x} Si_{0.106+y} S_{0.363−z} I_{0.113−w}, Li_{0.461+x} P_{0.076−y} S_{0.384−z} Br_{0.076+w}, Li_{0.4+x} Si_{0.04+y} P_{0.08−z} S_{0.48−w}, Li_{0.4+x} Si_{0.04+y} P_{0.08−z} S_{0.48−w}, Li {0.4+x} P_{0.08−y} S_{0.48−z} Sn_{0.04+w}, Li_{0.4+x} P_{0.08−y} S_{0.48−z} Sn_{0.04+w}, Li_{0.428+x} P_{0.142−y} S_{0.428−z}, Li_{0.423+x} Al_{0.038+y} P_{0.076−z} S_{0.461−w}, Li_{0.444+x} S_{0.444−y} Sn_{0.111−z}, Li_{0.433+x} S_{0.452−y} As_{0.018−z} Sn_{0.094−w}, Li_{0.485+x} P_{0.029−y} S_{0.367−z} Ge _{0.044+w} I_{0.073−1}, Li_{0.44+x} P_{0.08−y} S_{0.36−z} Cl_{0.108−w} I_{0.012+1}, Li_{0.44+x} P_{0.08−y} S_{0.36−z} Cl_{0.108−w} Br_{0.012+1}, Li_{0.44+x} P_{0.08−y} S_{0.36−z} Cl_{0.12−w}, Li_{0.44+x} F_{0.032−y} P_{0.08−z} S_{0.36−w} Cl_{0.088−1}, Li_{0.475+x} Si_{0.026+y} P_{0.048−z} S_{0.374−w} Br {0.074−1}, Li_{0.461+x} P_{0.076−y} S_{0.384−z} Cl_{0.076−w}, Li_{0.461+x} P_{0.076−y} S_{0.384−z} I_{0.076−w}, Li_{0.481+x} P_{0.074−y} S_{0.407−z} Cl_{0.037−w} and Li_{0.5+x} P_{0.071−y} S_{0.428−z}, where ‘_{#}’ and ‘{#+x, y, z, w, l, or m}’ represent non-stoichiometric weightings of an element immediately to the left of ‘_{#}’ or ‘_{# #x, y, z, w, l, or m}’ in a chemical formula of the material, wherein #can be in the range of #+n, wherein 0≤n≤0.5, wherein 0≤x, y, z, w, l, and m≤#, and wherein #can be En, 0≤n≤0.5.

The separator 113 is disposed between the anode 112 and the cathode 113. In some embodiments, the separator 113 may include a solid state electrolyte. In some embodiments, the separator 113 may include a first solid state electrolyte (not shown) disposed on the anode 112 and a second solid state electrolyte (not shown) disposed on the first solid state electrolyte. In some embodiments, the first solid state electrolyte may be stable with respect to an alkali metal, for example, the alkali metal included in the anode 112. Moreover, the second solid state electrolyte may be stable with respect to the alkali metal. Thus, the first solid state electrolyte may allow any dendrites growing from the anode 112 towards the cathode 114 to pass therethrough, and the second solid state electrolyte may react with and consume the dendrites to prevent the dendrites from passing through the second solid state electrolyte and contacting the cathode 114. In this manner, the bilayer solid state electrolyte may prevent short circuiting of the electrochemical cell.

In some embodiments, the first solid state electrolyte is selected from the group consisting of Li₆PS₅Cl, Li_{6±y}PS_{5±y}Cl_{1±y}, Li_{5.5}PS_{4.5}Cl_{1.5}, Li_{5.5±y}PS_{4.5±y}C_{11.5±y}, Li_{6±y}PS_{5±y}Br_{1±y}, Li_{6±y}PS_{5±y}I_{1±y}, Li_{6±y}PS_{5±y}F_{1±y}, Li₆PS₅Cl₁₋ₓFₓ (0≤x≤C), Li_{6±y}PS_{5±y}(Cl₁₋ₓFₓ)_{1±y}(0≤x≤C), Li_{6±y}PS_{5±y}(Cl₁₋ₓBrₓ)_{1±y}(0≤x≤C), Li_{6±y}PS_{5±y}(Cl₁₋ₓIₓ)_{1±y}(0≤x≤C), Li_{6±y}PS_{5±y}(BrᵤIᵥF_{w}Cl_{1-u-v-w})_{1±y}(0≤u,v,w≤C), LiₓP_{y}S_{z}(BrᵤIᵥF_{w}Cl_{1-u-v-w})ₚ (0≤u,v,w≤C, 0≤x,y,z,p≤7), Li₇P₂S₈I, Li₃PS₄, Li_{3±x}P_{1±y}S_{4±z}, 54Li₃PS₄-46LiI, xLi₃PS₄-(1-x)LiI, Li_{9.6}P₃S₁₂, Li₃ClO, Li₃BrO, Li₃BrₓCl₁₋ₓO, Li₇La₃Zr₂O₁₂, Li_{6.75}La₃Zr_{1.75}Ta_{0.5}O₁₂, Li_{6.75±x}La_{3±y}Zr_{1.75±z}Ta_{0.5±u}O_{12±v}, Li_{6.25}Al_{0.25}La₃Zr₂O₁₂, Li_{6.25±x}Al_{0.25±y}La_{3±z}Zr_{2±u}O_{12±v}, Li_{6.3}La₃Zr_{1.65}W_{0.35}O₁₂, Li_{6.3±x}La_{3±y}Zr_{1.65±z}W_{0.35±u}O_{12±v}, Li_{6.5}La₃Zr_{1.5}Nb_{0.5}O₁₂, Li_{6.5±x}La_{3±y}Zr_{1.5±2}Nb_{0.5±u}O_{12±v}, LiₓPO_{y}N_{z} (0≤x=2y±3z−5≤3), Li_{6.4}Ga_{0.2}La₃Zr₂O₁₂, Li_{6.4±x}Ga_{0.2±y}La_{3±u}Zr_{2±v}O_{12±w}, Li₃PO₄, Li₃YCl₆, Li₃YBr₆, Li₃InCl₆, Li₃InBr₆, Li₃ErCl₆, Li₃ErBr₆, Li₃ScCl₆, Li₃ScBr₆, and Li₃(YₓIn_{y}Sc_{1-x-y})(FᵤBrᵥCl₁₋ᵤ₋ᵥ)₆, wherein 0≤a, b, d, p, q, w, x, y, z, u, v, and w≤1 unless otherwise specified, wherein C is the critical doping content, above which the electrolyte become less stable, and wherein C can be varied for u, v, and w; 0≤C≤1.

In some embodiments, the second solid state electrolyte is selected from the group consisting of Li₁₀GeP₂S₁₂, Li_{10±x}Ge_{1±y}P_{2±p}S_{12±q}, Li_{10±x}Ge_{1±y}(PpSb₂₋ₚ)S_{12±q}, Li₁₀SiP₂S₁₂, Li_{10±x}Si_{1±y}P_{2±p}S_{12±q}, Li₁₀SnP₂S₁₂, Li_{10±x}Sn_{1±y}P_{2±p}S_{12±q}, Li_{10±x}Sn_{1±y}(PₚSb₂₋ₚ)S_{12±q}, Li_{6±y}P₍₁₋ₓ₎SbₓS_{5±y}(BrᵤIᵥF_{w}Cl_{1-u-v-w})_{1±y}(x≥C, 0≤u,v,w≤1), Li_{6±y}P₍₁₋ₓ₎SbₓS_{5±y}(BrᵤIᵥF_{w}Cl_{1-u-v-w})_{1±y}(u,v,w≥C, 0≤x≤1), Li_{3±x}P_{1±y}S_{4±z}, Li_{9.54}Si_{1.74}P_{1.44}S_{11.7}Cl_{0.3}, Li_{10±x}Si_{1±y}P_{2±p}S_{12±q}Cl_{w}, Li_{9.54}Si_{1.74}(PₓSb₁₋ₓ)_{1.44}S_{11.7}Cl_{0.3}, Li_{10±x}Si_{1±y}(PₓSb₁₋ₓ)_{2±p}S_{12±q}Cl_{w}, Li_{10±x}Si_{1±y}(PₓSb_{1- x})_{2±p}S_{12±q}(FᵤBrᵥI_{w}Cl_{1-u-v-w})_{z}, Li_{10±x}(SiₐSn_{b}Ge_{1-a-b})_{1±y}(PₓSb₁₋ₓ)_{2±p}(SₐSe_{1-d})_{12±q}(FᵤBrᵥI_{w}Cl_{1-u-v-w})_{z}, Li_{3.2}P_{0.8}Sn_{0.2}S₄, Li_{3.2±x}P_{0.8±y}Sn_{0.2±z}S_{4±u}, Li—P₃S₁₁, 75Li₂S-25P₂S₅, (x)Li₂S-(1-x)P₂S₅, Li₇Ge₃PS₁₂, Li_{1.5}Al_{0.5}Ti_{1.5}(PO₄)₃, Li_{7±x}Ge_{3±y}P_{1±z}S_{12±u}, Li₆PS₅Cl₁₋ₓFₓ (x≥C), Li_{6±y}PS_{5±y}(Cl₁₋ₓFₓ)_{1±y}(x≥C), Li_{6±y}PS_{5±y}(Cl₁₋ₓBrₓ)_{1±y}(x≥C), Li_{6±y}PS_{5±y}(Cl₁₋ₓIₓ)_{1±y}(x≥C), Li_{6±y}PS_{5±y}(BrᵤIᵥF_{w}Cl_{1-u-v-w})_{1±y}(u,v,w≥C), LiₓP_{y}S_{z}(BrᵤIᵥF_{w}Cl_{1-u-v-w})ₚ (u,v,w≥C, 0≤x,y,z,p≤7), nLiX-xACl₃-(1-x)GaF₃ (n=2, 3, 4, X=Cl, Br, A=La, In), nLiCl-LiOH—GaF₃ (n=2, 3, 4), and nLiX-GaF₃ (X=Cl, Br, n=2, 3, 4), wherein 0≤a, b, d, p, q, w, x, y, z, u, v, and w≤1 unless otherwise specified, wherein C is the critical doping content, above which the electrolyte become less stable, and wherein C can be varied for u, v, and w; 0≤C≤1.

In some embodiments, the first solid state electrolyte is selected from the group consisting of Na₃PS₄, Na_{3±x}P_{1±y}S_{4±z}, Na_{2.9375}PS_{3.9375}Cl_{0.0625}, Na_{3±x}P_{1±y}S_{4±z}Cl_{w}, Na_{3±x}(P₁₋ᵤ₋ᵥSbᵤWᵥ)_{1±y} (S_{1-w}Se_{w})_{4±z} (0≤u,v,w<C), Na₃YCl₆, Na₃YBr₆, Na₃InCl₆, Na₃InBr₆, Na₃ErCl₆, Na₃ErBr₆, Na₃ScCl₆, Na₃ScBr₆, Na₃(YₓIn_{y}Sc_{1-x-y})(FᵤBrᵥCl₁₋ᵤ₋ᵥ), and Na₃(YₓIn_{y}Sc_{z}X_{1-x-y-z})(FᵤBrᵥCl₁₋ᵤ₋ᵥ)₆ (X=transition metal), wherein O≤p, q, w, x, y, z, u, v, and w≤1 unless otherwise specified, wherein C is the critical doping content above which the electrolyte become less stable, and wherein C can be varied for u, v, and w; 0≤C≤1.

In some embodiments, the second solid state electrolyte is selected from the group consisting of Na₁₀GeP₂S₁₂, Na_{10±x}Ge_{1±y}P_{2±p}S_{12±q}, Na_{10±x}Ge_{1±y}(PₚSb₂₋ₚ)S_{12±q}, Na_{10±x}(GeᵤSi_{z}Sn_{1-u- z})_{1±y}(PᵥAsᵢSb₁₋ᵥ₋ᵢ)_{2±p}(S_{w}Se_{1-w})_{12±q}, Na_{2.88}Sb_{0.88}W_{0.12}S₄, Na_{2.88±x}Sb_{0.88±y}W_{0.12±z}S_{4±w} and Na_{3±x}(P₁₋ᵤ₋ᵥSbᵤWᵥ)_{1±y}(S_{1-w}Se_{w})_{4±z} (u,v,w≥C), wherein 0≤p, q, w, x, y, z, u, v, and w≤1 unless otherwise specified, wherein C is the critical doping content above which the electrolyte become less stable, and wherein C can be varied for u, v, and w; 0≤C≤1.

In some embodiments, the first solid state electrolyte is selected from the group consisting of Li_{0.3} Cl_{0.6} Er_{0.1}, Li_{0.3} Cl_{0.6} Y_{0.1}, Li_{0.3} Cl_{0.6} Sc_{0.1}, Li_{0.291} O_{0.5} Zr_{0.083} La_{0.125}, Li_{0.271} O_{0.508} Ga_{0.008} Zr_{0.084} La_{0.127}, Li_{0.265} O_{0.510} Al_{0.010} Zr_{0.085} La_{0.127}, Li_{0.276} O_{0.510} Zr_{0.063} Nb_{0.021} La_{0.127}, Li_{0.270} O_{0.515} Zr_{0.070} La_{0.128} W_{0.015}, Li_{0.400−x} B_{0.000−y} O_{0.000−z} Al_{3.503+w} Si_{0.133−1} S_{0.465−m}, Li_{0.3+x} CI_{0.6−y} Sc_{0.1−z}, Li_{0.3+x} CI_{0.6−y} In_{0.1−z}, Li_{0.3+x} CI_{0.6−y} Er_{0.1−z}, Li_{0.3+x} CI_{0.6−y} Y_{0.1−z}, Li_{0.444+x} S_{0.444−y} Sn {0.111−z}, Li_{0.44+x} P_{0.08−y} S_{0.36−z} CI_{0.12−w}, Li_{0.270+x} O_{0.515−y} Zr_{0.070−z} La_{0.128+w} W_{0.015−1}, Li_{0.265+x} O_{0.510−y} Al_{0.010−z} Zr_{0.085+w} La_{0.127+1}, Li_{0.291+x} O_{0.5−y} Zr_{0.083−z} La_{0.125−w}, Li_{0.276+x} O_{0.510−y} Zr_{0.063+z} Nb_{0.021−w} La_{0.127+1} and Li_{0.166+x} B_{0.166−y} O_{0.5−z} Al_{0.125±w} Cl_{0.041±1}, wherein ‘{#}’ and ‘{#±x, y, z, w, l, or m}’ represent non-stoichiometric weightings of an element immediately to the left of ‘_{#}’ or ‘_{##x, y, z, w, 1, or m}’ in a chemical formula of the material, wherein #can be in the range of #±n, wherein 0≤n≤0.5, wherein 0≤x, y, z, w, l, and m≤#, and wherein #can be ±n, 0≤n≤0.5.

In some embodiments, the second solid state electrolyte is selected from the group consisting of Li_{0.6} O_{0.2} Cl_{0.2}, Li_{0.6} O_{0.2} Br_{0.2}, Li_{0.3} Br_{0.6} Er_{0.1}, Li_{0.3} Br_{0.6} Y_{0.1}, Li_{0.3} Sc_{0.1} Br_{0.6}, Li_{0.3} Br_{0.6} In_{0.1}, Li_{0.375} O_{0.5} P_{0.125}, Li_{0.3} CI_{0.6} In_{0.1}, Li_{0.166} B_{0.166} O_{0.5} Al_{0.125} Cl_{0.041}, Li_{0.444} S_{0.444} Sn_{0.111}, Li_{0.416} Si_{0.106} S_{0.363} I_{0.113}, Li_{0.428} P_{0.142} S_{0.428}, Li_{0.485} P_{0.029} S_{0.367} Ge_{0.044} I_{0.073}, Li_{0.433} S_{0.452} As_{0.018} Sn_{0.094}, Li_{0.325} B_{0.181} S_{0.377} I_{0.115}, Li_{0.475} Si_{0.026} P_{0.048} S_{0.374} Br_{0.074}, Li_{0.461} O_{0.076} P_{0.076} S_{0.307} CI_{0.076}, Li_{0.400} B_{0.000} O_{0.000} Al_{3.503} Si_{0.133} S_{0.465}, Li_{0.461} P_{0.076} S_{0.384} I_{0.076}, Li_{0.44} P_{0.08} S_{0.36} CI_{0.108} Br_{0.012}, Li_{0.44} P_{0.08} S_{0.36} Cl_{0.108} I_{0.012}, Li_{0.44} P_{0.08} S_{0.36} Cl_{0.12}, Li_{0.388} P_{0.111} S_{0.444} I_{0.055}, Li_{0.6+x} O_{0.2+y} Br_{0.2−z}, Li_{0.6−x} O_{0.2−y} Cl_{0.2+z}, Li_{0.3+x} Br_{0.6−y} In {0.1−z}, Li_{0.3+x} Br_{0.6−y} Y_{0.1−z}, Li_{0.3+x} Br_{0.6−y} Er_{0.1−z}, Li_{0.416+x} Si_{0.106+y} S_{0.363−z} I_{0.113−w}, Li_{0.3+x} Sc_{0.1−y} Br_{0.6−z}, Li_{0.166+x} B_{0.166−y} O_{0.5−z} Al_{0.125+w} Cl_{0.041+1}, Li_{0.375+x} O_{0.5−y} P_{0.125−z}, Li_{0.485+x} P_{0.029−y} S_{0.367−z} Ge_{0.044+w} I_{0.073−1}, Li_{0.5+x} P_{0.071−y} S_{0.428−z}, Li_{0.461+x} P_{0.076−y} S_{0.384−z} I_{0.076−w}, Li_{0.433+x} S_{0.452−y} As_{0.018−z} Sn_{0.094−w}, Li_{0.481+x} P_{0.074−y} S_{0.407−z} Cl {0.037−w}, Li_{0.461+x} O_{0.076+y} P_{0.076−z} S_{0.307−w} Cl_{0.076−1}, Li_{0.475+x} Si_{0.026+y} P_{0.048−z} S_{0.374−w} Br_{0.074−1}, Li_{0.461+x} P_{0.076−y} S_{0.384−z} Br_{0.076+w}, Li_{0.461+x} P_{0.076−y} S_{0.384−z} Cl_{0.076−w}, Li_{0.44+x} P_{0.08−y} S_{0.36−z} CI_{0.108−w} Br_{0.012+1}, Li_{0.44+x} P_{0.08−y} S_{0.36−z} CI_{0.108−w} I_{0.012+1}, Li_{0.428+x} P_{0.142−y} S_{0.428−z}, Li_{0.423+x} Al_{0.038+y} P_{0.076−z} S_{0.461−w}, Li_{0.4+x} Si_{0.04+y} P_{0.08−z} S_{0.48−w}, Li_{0.4+x} Si_{0.04+y} P_{0.08−z} S_{0.48−w}, Li_{0.44+x} F_{0.032−y} P_{0.08−z} S_{0.36−w} Cl_{0.088−1}, Li_{0.4+x} P_{0.08−y} S_{0.48−z} Sn_{0.04+w}, Li_{0.4+x} P_{0.08−y} S_{0.48−z} Sn_{0.04+w}, Li_{0.385+x} Si_{0.070+y} P_{0.058−z} S_{0.473−w} Cl_{0.012−1}, Li_{0.388+x} P_{0.111+y} S_{0.444−z} I_{0.055+w}, Li_{0.385+x} Si_{0.070+y} P_{0.052−z} S_{0.473−w} Cl_{0.012−1} Sb_{0.005−m}, Li_{0.310+x} P_{0.152+y} S_{0.537−z}, Li_{0.375+x} P_{0.125+y} S_{0.5−z}, Li_{0.308+x} P_{0.153+y} S_{0.536−z} I_{0.001−w}, Li_{0.333+x} P_{0.142+y} S_{0.523−z}, Li_{0.333+x} P_{0.142+y} S_{0.523−z}, Li {0.333+x} P_{0.142+y} S_{0.523−z}, Li_{0.333+x} P_{0.138+y} S_{0.509−z} Mn_{0.004−w} I_{0.014+1}, Li_{0.260+x} P_{0.173+y} S_{0.565−z}, Li_{0.390+x} P_{0.121+y} S_{0.487−z}, Li_{0.337+x} P_{0.139+y} S_{0.522−z} Mo_{0.000+w}, Li_{0.390+x} P_{0.097+y} S_{0.487−z} Sn_{0.024+w}, Li_{0.004+x} Li_{0.373+y} B_{0.001−z} P_{0.124+w} S_{0.496−1}, Li_{0.393+x} P_{0.090+y} S_{0.484−z} Ge_{0.030+w}, Li_{0.4+x} P_{0.08+y} S_{0.48−z} Ge_{0.04+w}, Li_{0.304+x} P_{0.043+y} S_{0.521−z} Ge_{0.130+w}, Li_{0.325−x} B_{0.181+y} S_{0.377+z} I_{0.115−w} and Li_{0.081+x} O_{0.648−y} Al_{0.027+z} P_{0.162−w} Ti_{0.081−1}, wherein ‘{#}’ and ‘_{#±x, y, z, w, l, or m}’ represent non-stoichiometric weightings of an element immediately to the left of ‘_{#}’ or ‘_{#±x, y, z, w, l, or m}’ in a chemical formula of the material, wherein #can be in the range of ##n, wherein 0≤n≤0.5, wherein 0≤x, y, z, w, l, and m≤#, and wherein #can be ±n, 0≤n≤0.5.

In some embodiments, the first solid state electrolyte is selected from the group consisting of Na_{0.300} Cl_{0.600} Y_{0.100}, O_{0.2} Na_{0.6} Br_{0.2}, Na_{0.291} Cl_{0.607} Y_{0.088} Zr_{0.012}, Na_{0.282} Cl_{0.615} Y_{0.076} Zr _{0.025}, H_{0.600} Na_{0.300} Al_{0.100}, H_{0.46} B_{0.46} Na_{0.08}, O_{0.6} Al_{0.4}, H_{0.458} B_{0.458} Na_{0.083}, O_{0.588} Na {0.166} Si_{0.098} P_{0.049} Sc_{0.019} Zr_{0.078}, H_{0.666} Na_{0.166} Al_{0.166}, O_{0.614} Na_{0.067} Zr_{0.204} La_{0.112}, H_{0.454} B_{0.454} Na_{0.090}, O_{0.6} Na {0.15} Si_{0.1} P_{0.05} Zr_{0.1}, Na_{0.272} Cl_{0.623} Y_{0.064} Zr_{0.038}, O_{0.588} Na_{0.166} Si_{0.098} P_{0.049} Zn {0.009} Zr_{0.088}, O_{0.601} Na {0.066} Sr_{0.066} Zr_{0.200} La_{0.066}, Na_{0.263} Cl_{0.631} Y_{0.052} Zr_{0.052}, Na_{0.243+x} Cl_{0.648−y} Y_{0.027+z} Zr_{0.081+w}, O_{0.2+x} Na_{0.6+y} Br_{0.2−z}, Na_{0.300−x} Cl_{0.600−y} Y_{0.100+z}, Na_{0.232+x} Cl_{0.657−y} Y_{0.013+z} Zr_{0.095+w}, Na_{0.263+x} Cl_{0.631−y} Y_{0.052+z} Zr_{0.052+w}, Na_{0.253+x} Cl_{0.640−y} Y_{0.040+z} Zr_{0.066−w}, Na_{0.291−x} Cl_{0.607+y} Y_{0.088+z} Zr_{0.012+w}, Na_{0.282−x} Cl_{0.615+y} Y_{0.076+z} Zr_{0.025−w}, Na_{0.272−x} Cl_{0.623+y} Y_{0.064+z} Zr_{0.038−w}, H_{0.600+x} Na_{0.300−y} Al_{0.100+z}, O_{0.588−x} Na_{0.166+y} Si_{0.098+z} P_{0.049−w} Sc_{0.019+1} Zr_{0.078+m}, Na_{0.370+x} P_{0.125+y} S_{0.496−z} Cl_{0.007−w}, O_{0.614−x} Na_{0.067−y} Zr_{0.204−z} La_{0.112+w}, Na_{0.365+x} S_{0.507−y} Sb {0.111−z} W_{0.015+w}, O_{0.601−x} Na_{0.066+y} Sr_{0.066+z} Zr_{0.200+w} La_{0.066+1}, O_{0.588−x} Na_{0.166+y} Si_{0.098+z} P_{0.049−w} Zn_{0.009−1} Zr {0.088+m}, Na_{0.379+x} Si_{0.007−y} P_{0.116+z} S_{0.496−w}, O_{0.631−x} Na {0.157+y} P_{0.157−z} La_{0.052+w}, Na_{0.347+x} P_{0.127+y} S_{0.508−z} Ca_{0.017−w}, Na_{0.423+x} P_{0.038+y} S_{0.461−z} Sn_{0.076−w}, Na_{0.375+x} P_{0.125+y} S_{0.5−z}, O_{0.6−x} Na_{0.15+y} Si_{0.1+z} P_{0.05−w} Zr_{0.1−1}, Na_{0.423+x} S_{0.461−y} Sn_{0.076+z} Sb_{0.038+w} and Na_{0.375+x} S_{0.5−y} Sb_{0.125+z}, wherein ‘{#}’ and ‘_{##x, y, z, w, l, or m}’ represent non-stoichiometric weightings of an element immediately to the left of ‘_{#}’ or ‘{#+x, y, z, w, l, or m}’ in a chemical formula of the material, wherein #can be in the range of #±n, wherein 0≤n≤0.5, wherein 0≤x, y, z, w, l, and m≤#, and wherein #can be ±n, 0≤n≤0.5.

In some embodiments, the second solid state electrolyte is selected from the group consisting of H_{0.444} B_{0.111} O_{0.111} Na_{0.333}, O_{0.142} Na_{0.571} I_{0.285}, Na_{0.423} P_{0.038} S_{0.461} Sn {0.076}, Na_{0.379} Si_{0.007} P_{0.116} S_{0.496}, Na_{0.375} P_{0.125} S_{0.5}, Na_{0.370} P_{0.125} S_{0.496} Cl_{0.007}, Na_{0.347} P_{0.127} S_{0.508} Ca_{0.017}, O_{0.2} Na_{0.6} Br_{0.12} I_{0.08}, Na_{0.375} P_{0.125} Se_{0.5}, O_{0.202} Na_{0.585} Br_{0.121} Sr_{0.010} I_{0.080}, Na_{0.365} S_{0.507} Sb_{0.111} W_{0.015}, Na_{0.423} P_{0.038} Se_{0.461} Sn_{0.076}, Na_{0.423} S_{0.461} Sn_{0.076} Sb_{0.038}, Na_{0.375} Se_{0.5} Sb_{0.125}, Na_{0.375} S_{0.5} Sb_{0.125}, Na_{0.378} S_{0.486} Sb_{0.121} 1_{0.013}, Na_{0.253} Cl_{0.640} Y_{0.040} Zr_{0.066}, Na_{0.243} Cl {0.648} Y_{0.027} Zr_{0.081}, Na_{0.232} Cl_{0.657} Y_{0.013} Zr_{0.095}, Na_{0.222} Cl_{0.666} Zr_{0.111}, O {0.631} Na_{0.157} P_{0.157} La_{0.052}, H_{0.454−x} B_{0.454+y} Na_{0.090+z}, H_{0.444−x} B_{0.111+y} O_{0.111+z} Na_{0.333−w}, H_{0.458−x} B_{0.458+y} Na_{0.083+z}, H_{0.46−x} B_{0.46+y} Na_{0.08+z}, H_{0.666+x} Na_{0.166−y} Al_{0.166−z}, O_{0.142+x} Na_{0.571+y} 1_{0.285−z}, Na_{0.375+x} P_{0.125+y} Se_{0.5−z}, Na_{0.378+x} S_{0.486−y} Sb_{0.121−z} 1_{0.013−w}, O_{0.2−x} Na_{0.6+y} Br_{0.12−z} I_{0.08+w}, O_{0.202+x} Na_{0.585+y} Br_{0.121−z} Sr_{0.010−w} I_{0.080+1}, Na_{0.375+x} Se_{0.5−y} Sb_{0.125+z}, Na_{0.423+x} P_{0.038+y} Se_{0.461−z} Sn_{0.076+w}, O_{0.6−x} Al_{0.4+y} and Na_{0.222+x} Cl_{0.666−y} Zr_{0.111+z}, wherein ‘{#}’ and ‘{##x, y, z, w, l, or m}’ represent non-stoichiometric weightings of an element immediately to the left of ‘_{#}’ or ‘_{#±x, y, z, w, l, or m}’ in a chemical formula of the material, wherein #can be in the range of #±n, wherein 0≤n≤0.5, wherein 0≤x, y, z, w, l, and m≤#, and wherein #can be #n, 0≤n≤0.5.

In some embodiments, at least one of the first solid state electrolyte and the second solid state electrolyte has a core-shell particle structure. In some embodiments, the core and the shell of first solid state electrolyte and/or the second solid state electrolyte may include the same material, for example, any of the materials described herein. In some embodiments, the core may include a first material and the shell may include a second material that is different from the first material. The first and the second material can include any of the solid state electrolyte materials described herein.

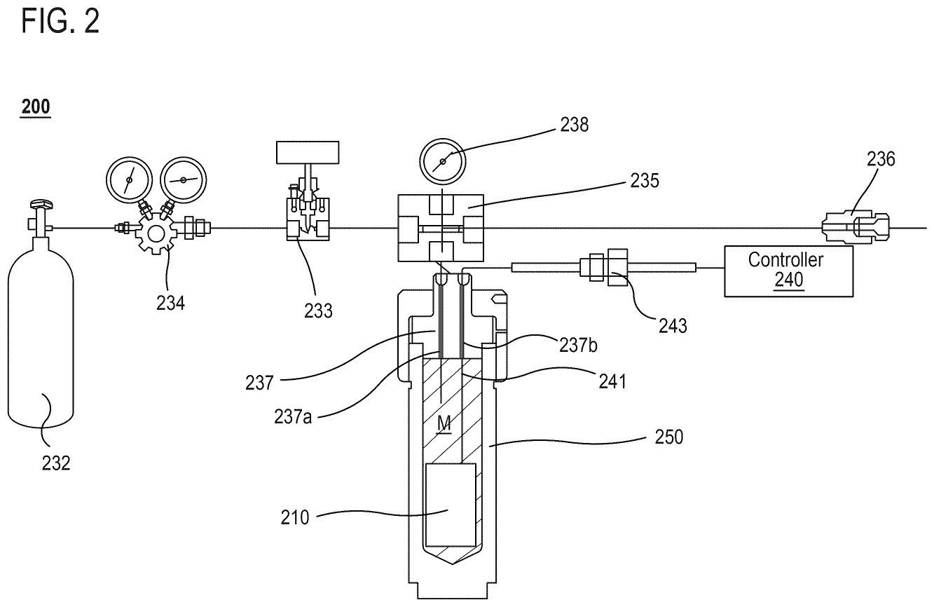

FIG. 2 is a schematic illustration of electrochemical cell system 200 for applying substantially uniform pressure on one or more electrochemical cells, according to an embodiment. The system 200 may include at least one electrochemical cell 210 disposed within a housing 250 defining an internal volume, a medium M disposed in the internal volume around the at least one electrochemical cell 210, a pressurizing system including a storage container 232, a pressure regulator 234, a valve 233, a pressure sensor 238, a fluidic connector 235 and a safety valve 236 fluidically coupled to each other as well as to the housing 250 via a manifold 237, a controller 240 electrically coupled to the at least one electrochemical cell 210, and an electrical feedthrough 243 including an electrical wire 241 that connects the at least one electrochemical cell 210 to the controller 240. While shown as having a particular structure and including particular components, the electrochemical cell system 200 can include any other components or combinations thereof to facilitate performance of the operations of the system 200. All such embodiments are envisioned and should be considered to be within the scope of the present application.

As shown in FIG. 2, the elements of the pressurizing system, i.e., the storage container 232, the pressure regulator 234, the valve 233, the pressure sensor 238, the fluidic connector 235 and the safety valve 236 can be connected or coupled to each other as well to the housing 250 via the manifold 237.

The manifold 237 may include one or more pressure resistant pipes and/or tubes. In some embodiments, the manifold 237 withstand an internal pressure up to about 50 MPa to about 100 MPa, inclusive (e.g., about 50 MPa, about 60 MPa, about 70 MPa, about 80 MPa, about 90 MPa, or about 100 MPa, inclusive).

The manifold 237 can be made of a strong and rigid material including, but not limited to, stainless steel, carbon steel, alloy steel, duplex stainless steel, nickel alloys, titanium, copper and copper alloys, and high-strength polymer-based materials. Various fittings and connectors, e.g., flanges, couplings, and adapters, can be used to join the pressure resistant pipes and tubes together throughout electrochemical cell system 200. The manifold 237 may define a first passage 237a configured to be fluidically coupled to the manifold 235 to allow the medium M to be communicate into the internal volume of the housing 250 therethrough. Moreover, the manifold 237 may define a second passage 237b through which electrical lead(s) 241 (e.g., electrical leads, wires, connectors, conduits, etc.) may be routed from the electrochemical cell(s) 210 to the controller 240. One or more sealing members (e.g., gaskets, O-rings, sealants, etc.) may be disposed in each of the first and second passages 237a and 237b to substantially seal first and second passages 237a and 237b and reduce leakage of the medium M from the internal volume. In some embodiments, the electrical leads 241 may include one or more electrical wires (e.g., 2, 3, 4, or 5). Electrical wires are typically made of a conductor material (e.g., copper, aluminum) that allows the flow of electric current. The conductor material is often surrounded by an insulating layer, which prevents the flow of electric current to other objects and provides safety. In some embodiments, the insulating layer can include, but is not limited to, plastics like PVC (polyvinyl chloride) or PE (polyethylene), rubber and other synthetic materials.

The fluidic connector 235 may include a multiway fluidic connector, for example, a piping cross, which allows for the branching of fluid or gas flow within the pressurizing system in multiple directions within the electrochemical cell system 200. As illustrated in FIG. 2, the fluidic connector 235 distributes the fluid or gas coming from the storage container 232 to the housing 250, to the pressure sensor 238 and to the storage container 232 via the safety valve 236 and the pressure regulator 234. As shown in this implementation, the fluidic connector 235 has four ports or openings at right angles to each other, resembling a “plus” (+) sign, with one port on each of the four arms. In some embodiments, the fluidic connector 235 has four arms having a same diameter. In such embodiments, each arm has an internal pressure substantially similar to each other. In some embodiments, one or more of the arms of the fluidic connector 235 have a smaller diameter than the other arms. In such embodiments, each arm may have an internal pressure different and/or substantially similar to each other. While FIG. 2 shows the fluidic connector 235 as including a 4-way fluidic connector, any other multiway connector may be used to fluidically couple the housing 250 to the pressure regulator 238, the storage container 232, and/or the safety valve 236 (e.g., a Y-connector, a T-connector, a barb-connector, any other suitable connector or any suitable combination thereof).

The safety valve 236 (e.g., a check valve, a duck bill valve, a solenoid valve, a rupture disc, etc.) is configured to serve as a safety device to protect the system 200 from over pressurization. For example, the safety valve 236 may be configured to protect elements of the electrochemical cell system 200, for example, the manifold 237, the housing 250, the valve 233 or any of the system elements described herein. In some embodiments, the safety valve 236 is a non-reclosing device that is installed in the pressurizing system 200 to provide an opening that allows the pressurized fluid or gas to be safely vented to a designated discharge area, for example, when the pressure inside the internal volume of the housing 250 exceeds a predetermined pressure threshold. That is, the safety valve 236 may not open and close repeatedly to regulate pressure. In such embodiments, the safety valve 236 is a one-time-use device, and once it ruptures due to overpressure within the system, it needs to be replaced with a safety valve 236 to restore the system's pressure protection. The safety valve 236 relieves excess pressure by bursting or rupturing when the manifold 237 have an internal pressure above the predetermined pressure threshold. In some embodiments, the predetermined pressure threshold is in a range of about 15 MPa to about 5 MPa, inclusive (e.g., about 15 MPa, about 14 MPa, about 13 MPa, about 12 MPa, about 10 MPa, about 8 MPa, about 6 MPa, or about 5 MPa, inclusive). The safety valve 236 can be made of any suitable material that can withstand the environment and any corrosive or abrasive substances.

The pressure sensor 238 monitors and displays the pressure levels within electrochemical cell system 200, for example, an internal pressure of the manifold 237. In some embodiments, the pressure sensor 238 may include a mechanical pressure gage as shown in FIG. 2. In some embodiments, the pressure sensor 238 may include an electronic pressure sensor configured to convert the mechanical force exerted by the pressure into an electrical signal, which can then be processed and interpreted for various purposes such as control, monitoring, data logging, or alarming. In some embodiments, the pressure sensor 238 may include a Micro-Electro-Mechanical-System (MEMS) based pressure sensor. The pressure sensor 238 may help keep track of the pressure of the medium M during time and detect any abnormalities or deviations, as well as provide feedback to maintain the internal pressure within a predetermined range, which can be used in a closed loop feedback system to maintain the pressure of the medium M in the internal volume within a desired range, for example, below the predetermined pressure threshold, or a pressure for which the fluidic connector 235 is rated (e.g., in a range of about 80 MPa to about 150 MPa, inclusive). In some embodiments, the pressure sensor 238 can trigger alarms or shutdowns if pressure exceeds a predetermined pressure limit, preventing potential damage or hazardous situations. In such embodiments, the predetermined pressure limit is about 150 MPa, about 140 MPa, about 130 MPa, about 120 MPa, about 110 MPa, about 100 MPa, about 90 MPa, about 80 MPa, about 70 MPa, about 60 MPa, or about 50 MPa. In some embodiments, the pressure sensor 238 may incorporate a temperature compensation mechanism to ensure accurate measurements in varying temperature conditions.

Referring to FIG. 2, the pressurizing system 200 may also include the storage container 232, the pressure regulator 234 and the valve 233 situated upstream of the fluidic connector 235. The valve 233 may control flow of a fluid throughout the pressurizing system, for example, to selectively allow flow of the fluid from the storage container 232. In some embodiments, the valve 233 may include one or more valves that can be operated manually and/or automatically. In some embodiments, the valve 233 further controls efficient flow of a fluid from the storage container 232 to the housing 250. In some embodiments, the valve 233 can include T-valves, gate valves, globe valves, ball valves, check valves, solenoid valves, diaphragm valves, needle valves butterfly valves, any other suitable valve or any suitable combination thereof.

The storage container 232 is configured to hold or contain a volume of a fluid for communicating to the housing 250. In some embodiments in which the fluid includes a gas, the storage container 232 can include a pressure tank or vessel configured to hold or contain the gas at a predetermined pressure. In some embodiments, the predetermined pressure is less than 50 MPa, 45 MPa, 40 MPa, 35 MPa, 30 MPa, 25 MPa, 20 MPa, 15 MPa, 10 MPa, 5 MPa or less. In some embodiments, the predetermined pressure is in a range of about 20 MPa to about 30 MPa, inclusive (e.g., about 20, 21, 22, 23, 24, 25, 26, 27, 28, 29, or 30 MPa, inclusive). In such embodiments, the gas may include, but is not limited to air, hydrogen, helium, nitrogen, argon, neon, krypton, xenon, any other suitable gas, or any suitable combination thereof. In some embodiments, the gas includes argon.

In some embodiments, the medium M includes a liquid. Suitable liquids may include, but are not limited to hydraulic fluids, silicone oils, mineral oils, non-aqueous fluids, electrolytes, any other suitable liquid, or a combination thereof. The liquid may include specific additives, e.g., abrasives, refrigerants, which may be mixed with liquids to enhance their performance and safety of the system 200. In such embodiments, a pump (e.g., a centrifugal pump, a positive displacement pump, a blower, a vacuum pump), or other pressurizing mechanism (e.g., an extruder in the case of a particulate matter based solid) may be used to pressurize the liquid. In some embodiments, the medium M disposed within the housing 250 is the same as the material within the storage container 232 (e.g., a gas or a liquid). In some embodiments, medium M disposed within the housing 250 is different than the material within the storage container 232. For example, the storage container 232 may include a gas, and the medium M may include solid particles. In another example, the storage container 232 may include a first type of gas, and the medium M may include mixture of gases including the first type of gas and a second type of gas.

The pressure regulator 232 may be substantially similar to the pressure regulator 134 described in detail with respect to the system 100. In some embodiments, the pressure regulator reduces the upstream pressure from the storage container 232 such that ratio of the upstream pressure from the storage container 232 to the downstream pressure after the pressure regulator 234 is in a range of about 1 to about 100, about 1 to about 80, about 1 to about 60, about 1 to about 40, about 1 to about 20, about 1 to about 10, about 1 to about 5, about 1 to about 4.5, about 1 to about 4, about 1 to about 3.5, about 1 to about 3, about 1 to about 2.5, about 1 to about 2, about 1 to about 1.5. In some embodiments, the upstream pressure from the storage container 232 is in a range of about 20 MPa to about 30 MPa, inclusive (e.g., about 20, 21, 22, 23, 24, 25, 26, 27, 28, 29, or 30 MPa, inclusive), and the downstream pressure after the pressure regulator is in range of about 0.5 MPa to about 10 MPa, inclusive (e.g., 0.5, 1, 2, 3, 4, 5, 6, 7, 8, 9, or 10 MPa, inclusive).

Referring again to FIG. 2, the housing 250 defines an internal volume in which the at least one electrochemical cell 210, for example, an electrochemical cell stack, and the medium M are disposed. The medium M is disposed between and in contact with the housing 250 and the at least one electrochemical cell 210. The electrochemical cell 210 may be substantially similar to the electrochemical cell 110 and therefore, not described in further detail herein. The medium M is also substantially similar to the medium M described above in connection with FIG. 1A.

In some embodiments, the housing 250 may be configured to be hermetically sealed to inhibit leakage of the medium M from within the internal volume thereof. In some embodiments, one or more openings (e.g., ports) can be provided on a wall, base, and/or lid of the housing 250, for example, the first passage 237a of the manifold 237, to allow medium M to be communicated into the internal volume of the housing 250, for example, to compensate for any medium M lost due to leaks. In some embodiments, the housing 250 has one or more openings to allow pass-through of the manifold 237. In such embodiments, as shown in FIG. 2, the housing 250 may have an opening that allow passage of the manifold 237 such that the housing 250 is fluidically coupled to the pressurizing system (e.g., to the storage container, to the upstream of the fluidic connector 235

While FIG. 2 shows the housing 250 as having a substantially rectangular shape, this is for illustrative purposes only and the housing 250 may have any other three-dimensional (3D) shape, for example, substantially cuboid, cylindrical, rectangular prism, pentagonal prism, hexagonal prism, trapezoidal prism, octagonal prism, any other suitable shape, or a combination thereof. In some embodiments, the housing is a pressure vessel. In some embodiments, the housing 250 is substantially similar to the housing 150 described above. The housing described herein may have a volume between 50 mL and 100 mL, 50 mL and 200 mL, 50 mL and 300 mL, 50 mL and 400 mL, 50 mL and 500 mL, 50 mL and 600 mL, 50 mL and 700 mL, 50 mL and 800 mL, 50 mL and 900 mL, 50 mL and 1000 mL, 50 mL and 1500 mL, 50 mL and 2000 mL, 50 mL and 3000 mL, 50 mL and 4000 mL, 50 mL and 5000 mL, 50 mL and 6000 mL, 50 mL and 7000 mL, 50 mL and 8000 mL, 50 mL and 9000 mL, and 50 mL and 1 L, inclusive, when the housing is filled with a fluid in the absence of the electrochemical cell 210. In some embodiments, the housing has a volume of about 500 mL. While not shown, in some embodiments, a scaffold (e.g., the scaffold 160 or any other scaffold described herein) may disposed in the housing and configured to hold or secure the electrochemical cells, as previously described herein.

As shown in FIG. 2, the electrochemical system 200 may include a controller 240, e.g., an electrochemical cell cycler, in electrical communication with the at least one electrochemical cell 210 disposed within the housing 250. The controller 240 can perform charge/discharge cycles on the electrochemical cell(s) 210 to determine certain properties of the electrochemical cell(s) 210 such as cell capacity, performance, and/or life cycle, or otherwise control operations of the electrochemical cell(s) 210. The controller 240 can perform at least one discharge/charge cycle on the at least one electrochemical cell 210 disposed in the housing 250 at a predetermined current density and at a predetermined temperature. Thermal chambers (not shown) may be used to create controlled temperature conditions for performing charge/discharge cycles on the electrochemical cell(s) 210 under different temperature conditions.

In some embodiments, the system 200 includes an electrical feedthrough 243 for electrical leads (e.g., the electrical leads 241), wires, or cables for electrically coupling the electrochemical cell(s) 210 disposed in the internal volume of the housing 250 to the controller 240 or other electronics (e.g., a battery management system, not shown) disposed outside of the internal volume of the housing 250. The electrical feedthrough 243 is designed to provide a secure and hermetic (airtight) seal while allowing electrical conductors (e.g., the electrical wire 241) to pass through the pressure boundary. In other words, the electrical feedthrough 243 can create a way to transmit electrical signals or power across a barrier that separates different pressure environments, such as from inside a housing 250 to the outside, without compromising the pressure containment.

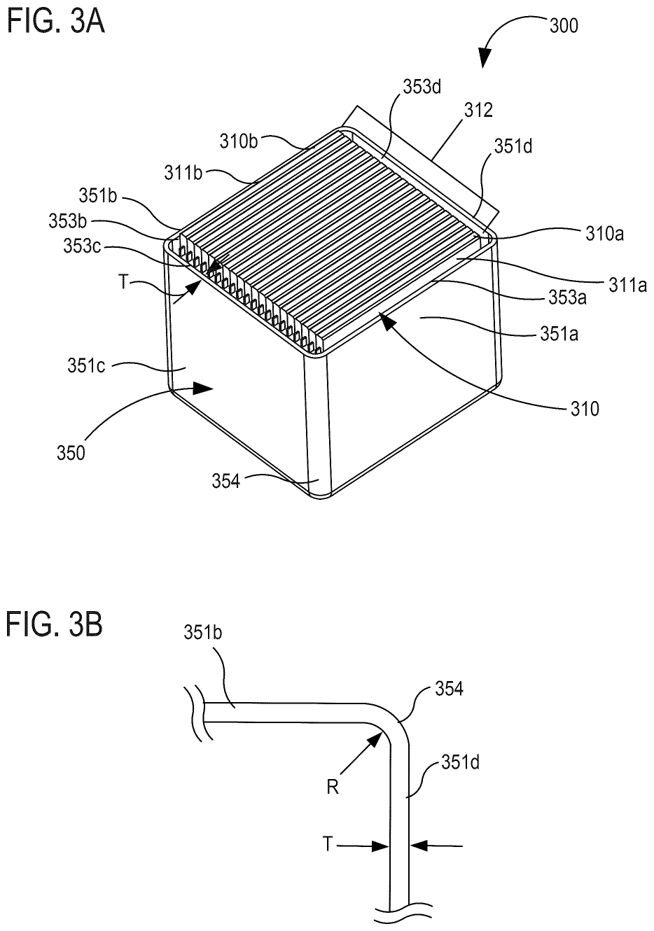

FIG. 3A is a top perspective view of a system 300 including an electrochemical cell stack 312 that includes a plurality of electrochemical cells 310 disclosed in a housing 350, according to an embodiment. The housing 350 includes a plurality of walls (351a, 351b, 351c and 351d), according to an embodiment. While FIG. 3A shows the housing 350 as having a substantially cuboid shape, this is for illustrative purposes only and the housing 350 may have any other three-dimensional (3D) shape, for example, substantially cylindrical, rectangular prism, pentagonal prism, hexagonal prism, trapezoidal prism, octagonal prism, any other suitable shape, or a combination thereof. As shown in FIG. 3A, the systems described herein can be adapted at the battery module level as compared to a pressure jig. The housing 350 serves the dual purposes of enclosing the electrochemical cell stack 312 and also serving as an internal volume in which a medium (e.g., the medium M) can be disposed and pressurized to exert a substantially uniform pressure or substantially isostatic pressure on the electrochemical cells 310. In some embodiments, the electrochemical cells 310a-310b included in the stack 310 can be inserted into the housing 350 in an uncompressed state and a substantially uniform force can be applied on the stack 310 by pressurizing the medium M disposed within the internal volume or subsequently communicated to the internal volume to exert the substantially uniform pressure or isostatic pressure on the electrochemical cells 310, thereby improving the performance and cycle life thereof.

In some embodiments, the electrochemical cells (e.g., pouch cells between 310a and 310b) may be stacked on top of each other. In some embodiments, the electrochemical cells (e.g., pouch cells between 310a and 310b) may be stacked side-by-side. In some embodiments, the electrochemical units (e.g., a battery unit consisting of cathode, anode and electrolyte) inside each pouch (e.g., pouch cell 310a or 310b) may be stacked side-by-side in series or in parallel. In such embodiments, at least two edges of the housing 350 that are parallel to the stacking direction have a width 312 that allows accommodation of at least 3, at least 5, at least 7, at least 10, at least 12, at least 15, at least 20, at least 24, at least 28, at least 30, at least 36, at least 40, at least 44, at least 48, at least 50, at least 54, at least 58, at least 60, at least 70, at least 80, or in between electrochemical cells (collectively referred to as 310).

In some embodiments, the stack 312 may be disposed in the housing 350 such that at least outer surfaces of stack 312 contact corresponding walls of the housing 350. For example, as shown in the implementation of FIG. 3A, an outer surface 311a of a first outer most electrochemical cell 310a included in the stack 312 contacts an inner surface 353a of the corresponding wall 351a that the electrochemical cell 310a faces. Moreover, an outer surface 311b of a second outermost electrochemical cell 310b of the stack 312 disposed opposite the electrochemical cell 310a contacts an inner surface 353b of the corresponding wall 351b that the electrochemical cell 310b faces. In contrast, there may be gaps or space an inner surface 353c and 353d of walls 351c and 351d, respectively, and corresponding edges of the stack 312. Thus, having a stack 312 that has a width corresponding to or substantially equal to a corresponding inner width of the housing 350 may allow the stack 312 to be secured within the housing 350, for example, to prevent movement of the stack 312 within the housing 350.

FIG. 3B is a top view of a portion of the first wall 351b and the adjacent second wall 351d of the housing 350 intersecting at a rounded corner 354, according to an embodiment. The corner 354 defines a radius of curvature R. The first wall and the second wall have a thickness of “T”. In some embodiments, the thickness T may be in a range of about 25 microns to about 1,000 mm, inclusive (e.g., about 25, 50, 75, 100, 500 microns; 1, 5, 10, 50, 100, 500, or 1,000 mm, inclusive). In some embodiments, the thickness T is at most 1,000 mm. In some embodiments, the thickness T is at most 500 mm. In some embodiments, the thickness T is at most 100 mm. In some embodiments, the thickness T is at most 50 mm. In some embodiments, the thickness T is at most 10 mm. In some embodiments, the thickness T is at most 5 mm. In some embodiments, the thickness T is at most 1 mm. In some embodiments, the thickness T is at most 0.5 mm. In some embodiments, the thickness T is at most 0.1 mm. In some embodiments, the thickness T is at most 50 microns.

In some embodiments, the thickness T is in a range of about 25 microns to about 1,000 mm, of about 25 microns to about 500 mm, of about 25 microns to about 100 mm, of about 25 microns to about 50 mm, about 25 microns to about 10 mm, about 25 microns to about 8 mm, about 25 microns to about 6 mm, about 25 microns to about 4 mm, about 25 microns to about 2 mm, about 25 microns to about 1 mm, about 25 microns to about 0.5 mm, about 25 microns to about 0.1 mm, about 25 microns to about 80 microns, about 25 microns to about 70 microns, about 25 microns to about 60 microns, about 25 microns to about 50 microns, about 25 microns to about 40 microns, about 25 microns to about 35 microns, about 25 microns to about 30 microns, about 100 microns to about 10 mm, about 200 microns to about 10 mm, about 300 microns to about 10 mm, about 400 microns to about 10 mm, about 500 microns to about 10 mm, about 600 microns to about 10 mm, about 700 microns to about 10 mm, about 800 microns to about 10 mm, about 900 microns to about 10 mm, about 1 mm to about 10 mm, about 2 mm to about 10 mm, about 3 mm to about 10 mm, about 4 mm to about 10 mm, about 5 mm to about 10 mm, about 6 mm to about 10 mm, about 7 mm to about 10 mm, about 8 mm to about 10 mm, about 9 mm to about 10 mm.

In some embodiments, the certain radius of curvature R may be in a range of about 0.1 mm to about 100 cm, inclusive (e.g., about 0.1, 0.5, 1, 1.5, 2.0, 2.5, 3.0, 3.5, 4.0, 4.5, 5.0, 10, 50, 100, or 500 cm; about 1, 10, 50, or 100 m, inclusive). In some embodiments, the certain radius of curvature R may be at least 0.1 mm. In some embodiments, the certain radius of curvature R may be at least 0.5 mm. In some embodiments, the certain radius of curvature R may be at least 0.1 cm. In some embodiments, the certain radius of curvature R may be at least 1 cm. In some embodiments, the certain radius of curvature R may be at least 1.5 cm. In some embodiments, the certain radius of curvature R may be at least 2 cm. In some embodiments, the certain radius of curvature R may be at least 2.5 cm. In some embodiments, the certain radius of curvature R may be at least 3 cm. In some embodiments, the certain radius of curvature R may be at least 3.5 cm. In some embodiments, the certain radius of curvature R may be at least 4 cm. In some embodiments, the certain radius of curvature R may be at least 4.5 cm.

In some embodiments, the certain radius of curvature R may be in a range of about 0.1 mm to about 1 mm, about 0.1 mm to about 10 mm, about 0.1 mm to about 1 cm, about 0.1 mm to about 1 cm, about 0.1 mm to about 2 cm, about 0.1 mm to about 3 cm, about 0.1 mm to about 4 cm, about 0.1 mm to about 5 cm, about 1 mm to about 5 cm, about 10 mm to about 5 cm, about 100 mm to about 5 cm, about 1 cm to about 5 cm, about 0.1 mm to about 100 mm, about 100 mm to about 1 cm, about 100 mm to about 5 cm, about 0.1 mm to about 5 cm, about 0.1 mm to about 5 cm.

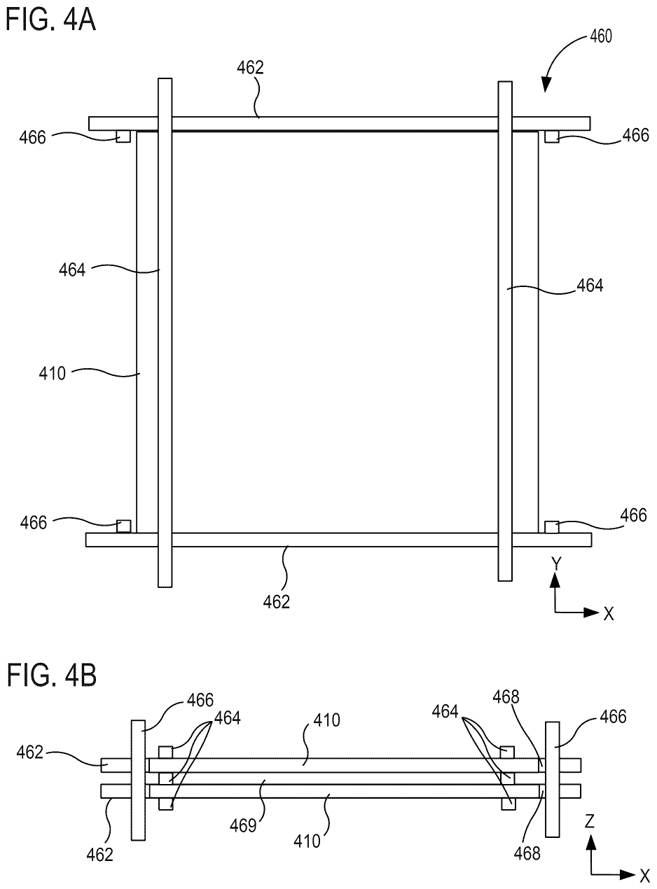

FIG. 4A is a side view and FIG. 4B is a top view of a scaffold 460 that may be used to mount, secure, or otherwise hold electrochemical cells 410 in an internal volume of a housing (e.g., the housing 150 or 350) such that a gap is provided between the electrochemical cells 410, according to an embodiment. The electrochemical cells 410 may be substantially similar to the electrochemical cells 110, and therefore not described in further detail herein. In this implementation, the scaffold 460 includes first elongate elements 462 (e.g., beams, bars, struts, arms, etc.) extending in a first direction (e.g., along the X-direction). Second elongate elements 464 may be coupled to the first elongate elements 462 and extend in a second direction that is orthogonal or otherwise non-parallel with the first direction (e.g., extend in the Y direction). In some embodiments, a third elongate elements 466 may be coupled to the first elongate elements 462 and extend in a third direction that is orthogonal to or otherwise non-parallel to the first or second direction (e.g., extend in the Z-direction). The elongate elements 462, 464, and optionally, 466 are coupled to form a cage like structure that defines slots 468 configured to hold or house one electrochemical cell 410, but in other embodiments, can be configured to hold or house more than one electrochemical cell 410. Moreover, a gap 469 is provided between adjacent slots 468 such that there is a gap between adjacent electrochemical cells 410 when disposed in the scaffold. The gap 469 allows the adjacent electrochemical cells 410 to expand freely, that may occur during charge/discharge cycling of the electrochemical cells 410. Moreover, the gap also allows a pressurized medium, for example, the medium M that may be communicated into a housing in which the scaffold is disposed to come in contact with surfaces of all of the electrochemical cells 410, this facilitating application of the substantially uniform or isostatic pressure on the electrochemical cells 410, as previously described herein.

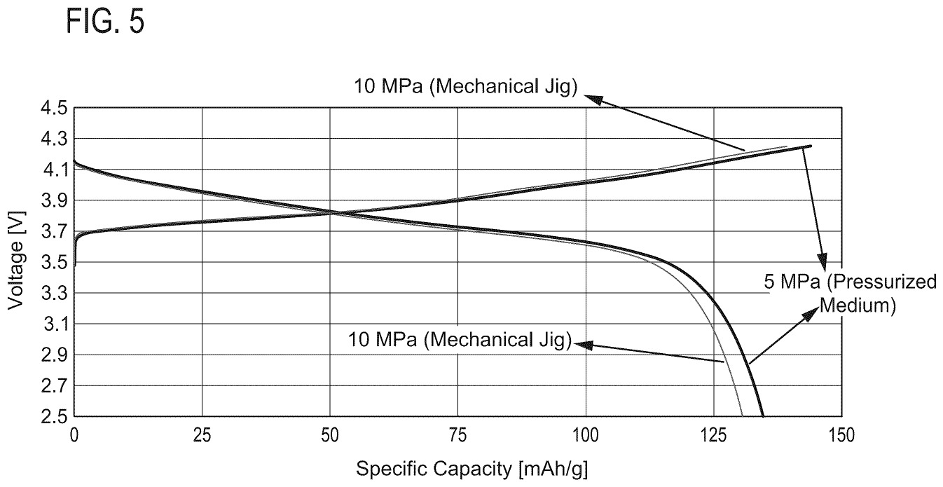

FIG. 5 illustrates the second charge (increasing voltage) and discharge (decreasing voltage) profiles of a solid-state electrochemical cell (e.g., the electrochemical cell 110, 210) disposed in an internal volume of a housing (e.g., the housing 150, 250, 350) having air at 5 MPa pressure serving as pressurized medium disposed in the internal volume vs. a solid-state electrochemical cell under 10 MPa pressure by a mechanical jig. An Example pouch cell similar to the electrochemical cell 110 described herein was disposed inside a pressure vessel having air at 5 MPa pressure serving as the pressurized medium M. As a control, an identical Comparative pouch cell was assembled inside of a steel pressure jig with a uniaxial pressure of 10 MPa being applied by the jig on the Comparative pouch cell. After a first charge/discharge cycle, which served as an initial formation cycle, each of the Example pouch cell and the Comparative pouch cell displayed substantially similar specific capacity at similar voltages, even though the substantially uniform pressure exerted by the air on the Example pouch cell was 50% of the uniaxial pressure exerted by the jig on the Comparative pouch cell, the methods and systems described herein enable improvement in performance of solid-state electrochemical cells by application of less than half of the pressure that would be applied by mechanical jigs to attain the same improvement in performance. In addition, the columbic inefficiency in the first cycle, which measures the amount of chemical side reactions during formation, was also considerably less in the pressure vessel than in the mechanical jig. First cycle columbic inefficiencies are −22.42% and −23.19% for 5 MPa pressure vessel and 10 MPa mechanical jig, respectively.

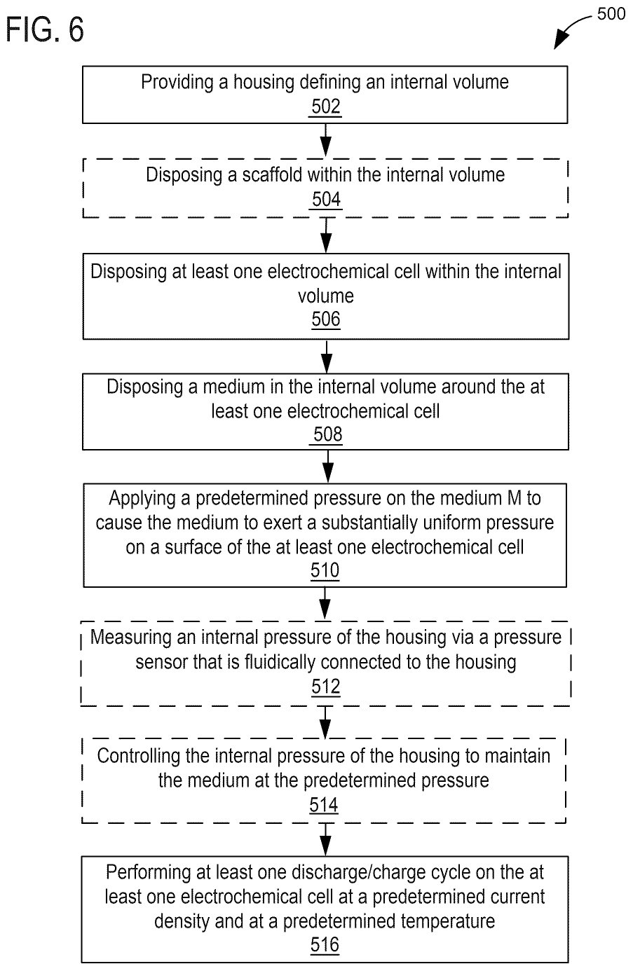

FIG. 6 is a schematic flow chart of a method 500 for applying a substantially uniform pressure on an electrochemical cell stack (e.g., a stack of the electrochemical cell 110, 210) disposed in a housing (e.g., the housing 150, 250, 350) via a pressurized medium M, according to an embodiment. While described with respect to the electrochemical cell 110, the housing 150, the pressure sensor 138, the pressure regulator 134 and the controller 140, and the scaffold 160, the method 500 is equally applicable to any electrochemical cell, housing, pressure sensor, pressure regulator or controller described herein. All such variations should be considered to be within the scope of this disclosure.

The method 500 includes providing the housing 150 defining an internal volume, at 502. In some embodiments, the scaffold 160 may optionally be disposed in the internal volume. at 504. At 506, at least one electrochemical cell 110, for example, an electrochemical cell stack, is disposed within the internal volume, for example, in the scaffold 160, as previously described herein.). Alternatively, the electrochemical cells 110 may be loaded or disposed in the scaffold outside the internal volume, and the loaded scaffold 160 then disposed within the housing 150. In some embodiment, the scaffold 160 may be integrally formed with the housing 150.

The method 500 further includes disposing a medium M in the internal volume around the at least one electrochemical cell 110, at 508. At 510, a predetermined pressure is applied on the medium M to cause the medium M to exert a substantially uniform pressure on a surface of the at least one electrochemical cell 110. In some embodiments, the pressurized medium M may be communicated into the housing 150 after the at least one electrochemical cell 110 has been disposed in the internal volume of the housing 150.

In some embodiment, the method 500 optionally includes measuring an internal pressure of the housing 150 via a pressure sensor 138 that is fluidically connected to the housing 150, at 512. In some embodiments, the method 500 further may include controlling the internal pressure of the housing 150 to maintain the medium M at the predetermined pressure, at 514. At 516, at least one discharge/charge cycle on the at least one electrochemical cell 110 is performed at a predetermined current density and at a predetermined temperature. The charge/discharge cycle of an electrochemical cell refers to the process of charging the electrochemical cell to store electrical energy and then discharging it to release that stored energy. The predetermined current density may vary depending on chemistry of the electrochemical cell 150 (e.g., type of anode material, cathode material). In some embodiments, the predetermined current density may be within the range of 0.05 C to 10 C, where C is the battery's capacity over hour. In some embodiments, the predetermined temperature may be between about −30° C. and about 90° C., between about −30° C. and about 0° C., between about −30 10° C. and about 90° C., between about −30° C. and about 20° C., between about −30° C. and about 30° C., between about −30° C. and about 40° C., between about −30° C. and about 50° C., between about −30° C. and about 60° C., between about −30° C. and about 70° C., between about −30° C. and about 80° C., between about −30° C. and about 90° C. In such embodiments, the predetermined temperature may be at around −5° C., around 0° C., around 5° C., around 10° C., around 15° C., around 15° C., around 20° C., around 25° C., around 30° C., around 40° C., around 50° C., around 60° C., or around 70° C.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. An electrochemical cell system, comprising:
a housing defining an internal volume;
an electrochemical cell disposed within the internal volume;
a medium disposed in the internal volume around the electrochemical cell; and
a pressurizing system operably coupled to the housing, the pressurizing system configured to apply a predetermined pressure on the medium to cause the medium to exert a substantially uniform pressure on a surface of the electrochemical cell.

2. The electrochemical cell system of claim 1, wherein the electrochemical cell comprises an anode disposed on an anode current collector, a cathode disposed on a cathode current collector, and a separator disposed between the anode and the cathode.

3. The electrochemical cell system of claim 2, wherein the separator includes a solid state electrolyte.

4. The electrochemical cell system of claim 2, wherein the electrochemical cell includes a liquid electrolyte.

5. The electrochemical cell system of claim 2, wherein the separator includes:
a first solid state electrolyte disposed on the anode, the first solid state electrolyte being stable with respect to an alkali metal; and
a second solid state electrolyte disposed on the first solid state electrolyte, the second solid state electrolyte being reactive with respect to the alkali metal.

6. The electrochemical cell system of claim 1, wherein the substantially uniform pressure is in a range of about 0.01 MPa to about 50 MPa.

7. The electrochemical cell system of claim 6, wherein the substantially uniform pressure is in a range of about 0.2 MPa to about 5 MPa.

8. The electrochemical cell system of claim 1, wherein the medium includes at least one of a gas, a liquid, or a low shear strength solid.

9. The electrochemical cell system of claim 8, wherein the low shear strength solid includes solid particles.

10. The electrochemical cell system of claim 1, wherein the medium includes at least one of a non-flammable material, a non-corrosive material, or a non-reactive material.

11. The electrochemical cell system of claim 1, wherein the medium is configured to capture or neutralize at least one byproduct generated during operation or failure of the electrochemical cell.

12. The electrochemical cell system of claim 11, wherein the at least one byproduct is a gas including at least one of H₂S, CO, HF, SO₂, NO₂, NO, HCl, or a toxic sulfide gas.

13. The electrochemical cell system of claim 1, wherein the housing comprises a plurality of walls, each of the plurality of walls having a thickness in a range of about 25 microns to about 1,000 mm.

14. The electrochemical cell system of claim 13, wherein each of the plurality of walls have rounded corners.

15. The electrochemical cell system of claim 14, wherein each of the rounded corners have a radius of curvature in a range of about 0.1 mm to about 100 m.

16. The electrochemical cell system of claim 1, wherein:
the electrochemical cell is included in an electrochemical cell stack, the electrochemical cell stack including a plurality of the electrochemical cells disposed on each other, and
outer surfaces of outer most electrochemical cells included in the electrochemical cell stack contact a corresponding inner surface of at least one of a respective wall of the plurality of walls of the housing or the medium.

17. The electrochemical cell system of claim 1, wherein the housing is substantially cuboid shaped or substantially cylindrical shaped.

18. The electrochemical cell system of claim 1, further comprising:
a controller electrically coupled to the electrochemical cell and configured to cause charge and discharge cycles to be performed on the electrochemical cell while the substantially uniform pressure is being exerted on the surface of the electrochemical cell.

19. The electrochemical cell system of claim 1, further comprising:
a scaffold disposed in the internal volume of the housing, the scaffold configured to hold the electrochemical cell in place during charge and discharge cycling.

20. The electrochemical cell system of claim 16, wherein the scaffold is configured to provide a space around the electrochemical cell such that the electrochemical cell can expand during charge and discharge cycling.

21. The electrochemical cell system of claim 1, further comprising:
a safety valve fluidically coupled to the housing, the safety valve configured to enable depressurizing of an internal pressure of the housing when the internal pressure within the internal volume exceeds a predetermined pressure or in the case of cell failure, thermal runaway, or other safety event.
